(19) United States
(12) Patent Application Publication
(10) Pub. No.: US 2026/0038739 A1
(43) Pub. Date: Feb. 5, 2026

(54) CAPACITOR

(71) Applicant: ROHM CO., LTD., Kyoto (JP)

(72) Inventor: Kazuhiro TAMURA, Kyoto (JP)

(73) Assignee: ROHM CO., LTD., Kyoto (JP)

(21) Appl. No.: 19/284,491

(22) Filed: Jul. 29, 2025

(30) Foreign Application Priority Data
Jul. 31, 2024 (JP) 2024-124576

(51) Int. Cl. H01G 4/232; H01G 2/02; H01G 4/005; H01G 4/08; H01G 4/33; H01G 4/38

(52) U.S. Cl. CPC H01G 4/232; H01G 2/02; H01G 4/005; H01G 4/08; H01G 4/33; H01G 4/38

(57) ABSTRACT

A capacitor includes a semiconductor substrate including a first substrate surface, an insulating layer provided over the first substrate surface, and a first electrode and a second electrode that are provided in the insulating layer and that oppose each other. The first electrode includes a first electrode plate and a plurality of first electrode parts. The second electrode includes a second electrode plate and a plurality of second electrode parts. The second electrode plate is positioned across the first electrode plate from the first substrate surface within the insulating layer so as to oppose the first electrode plate. The plurality of first electrode parts and the plurality of second electrode parts are disposed alternately in the X direction and oppose each other in the X direction. The first electrode plate is interposed between the plurality of second electrode parts and the semiconductor substrate.

### CROSS REFERENCE TO RELATED APPLICATION

This application is based upon and claims the benefit of priority of the prior Japanese Patent Application No. 2024-124576, filed on Jul. 31, 2024, the entire contents of which are incorporated herein by reference.

### TECHNICAL FIELD

The present disclosure relates to a capacitor.

### BACKGROUND ART

Japanese Patent Application Laid-Open Publication No. 2021-64873 discloses an AD converter (ADC) using a comparator having a capacitive DA converter (DAC). The capacitive DAC includes a capacitor.

### BRIEF DESCRIPTION OF THE DRAWINGS

FIG. 1 is a schematic perspective view of an example capacitor according to Embodiment 1.

FIG. 2 is a schematic plan view of the capacitor shown in FIG. 1.

FIG. 3 is a schematic cross-sectional view of the capacitor along the F3-F3 line of FIG. 2.

FIG. 4 is a schematic cross-sectional view of the capacitor along the F4-F4 line of FIG. 2.

FIG. 5 is a schematic cross-sectional view of the capacitor along the F5-F5 line of FIG. 2.

FIG. 6 is a schematic perspective view of a typical capacitor according to Embodiment 2.

FIG. 7 is a schematic plan view of the capacitor shown in FIG. 6.

FIG. 8 is a schematic cross-sectional view of the capacitor along the F8-F8 line of FIG. 7.

FIG. 9 is a schematic cross-sectional view of the capacitor along the F9-F9 line of FIG. 7.

FIG. 10 is a schematic circuit diagram of an ADC using a comparator having a capacitive DAC.

FIG. 11 is a schematic cross-sectional view of a capacitor according to a modification example.

FIG. 12 is a schematic cross-sectional view of a capacitor according to a modification example.

FIG. 13 is a schematic cross-sectional view of a capacitor according to a modification example.

FIG. 14 is a schematic cross-sectional view of a capacitor according to a modification example.

FIG. 15 is a schematic plan view of a capacitor according to a modification example.

FIG. 16 is a schematic cross-sectional view of a capacitor according to a modification example.

FIG. 17 is a schematic plan view of a capacitor according to a modification example.

### DETAILED DESCRIPTION OF EMBODIMENTS

Some embodiments of a capacitor according to the present disclosure will be explained below with reference to attached drawings. In order to simplify and clarify the explanation, the constituent elements shown in the drawings are not necessarily depicted at a uniform scale. For ease of understanding, hatching lines are sometimes omitted from the cross-sectional views. The attached drawings are merely for the purpose of illustrating the embodiments of the present disclosure, and should not be interpreted as limiting the present disclosure.

The detailed description below includes a device, a system, and a method for implementing exemplary embodiments of the present disclosure. The detailed description is typically for the sole purpose of explanation, and is not intended to limit the embodiments of the present disclosure, or to limit application and use of such embodiments.

Language such as “first,” “second,” “third,” or the like in the present disclosure is used merely as labels, and is not necessarily intended to indicate the sequence of the objects with such labels.

The phrase “at least one” used in the present disclosure signifies “one or more” desired options. As one example, if there are two options, then the phrase “at least one” used in the present disclosure signifies only one of the options, or both options. As another example, if there are three or more options, then the phrase “at least one” used in the present disclosure signifies only one of the options, or a combination of any two or more options.

Language used in the present disclosure such as “the dimension (width or length) or A is equal to the dimension (width or length) of B” or “the dimension (width or length) of A and the dimension (width or length) of B are equal to each other” also includes cases where the difference between the dimension (width or length) of A and the dimension (width or length) of B is 10% or less of the dimension (width or length) of A.

### Embodiment 1

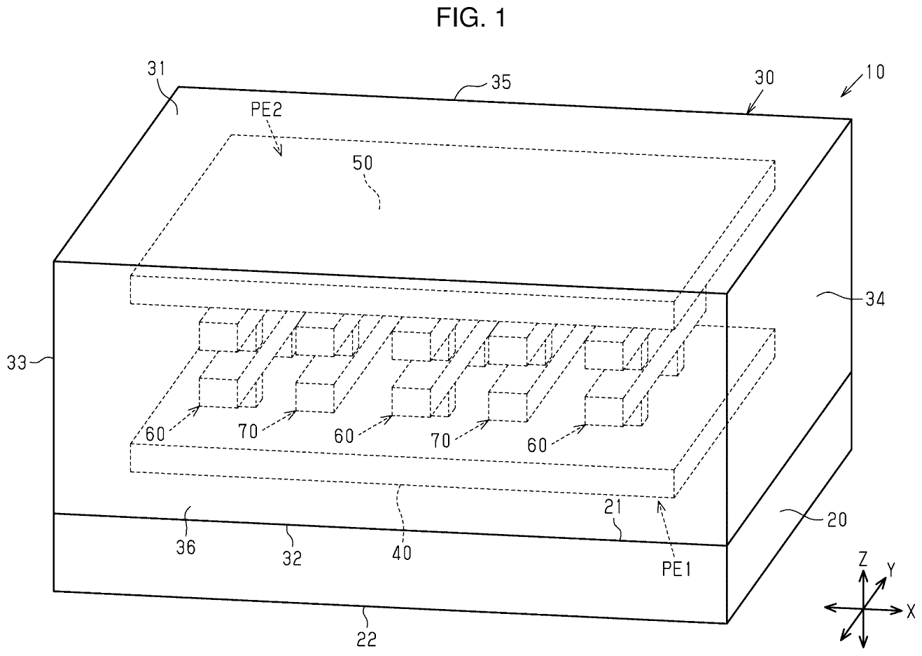

The configuration of a capacitor 10 according to Embodiment 1 will be described below with reference to FIGS. 1 to 5.

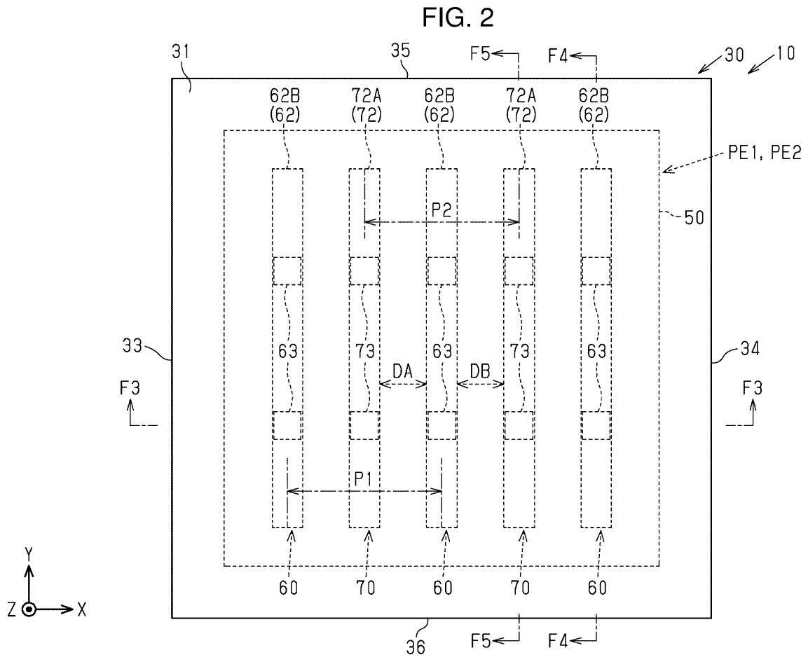

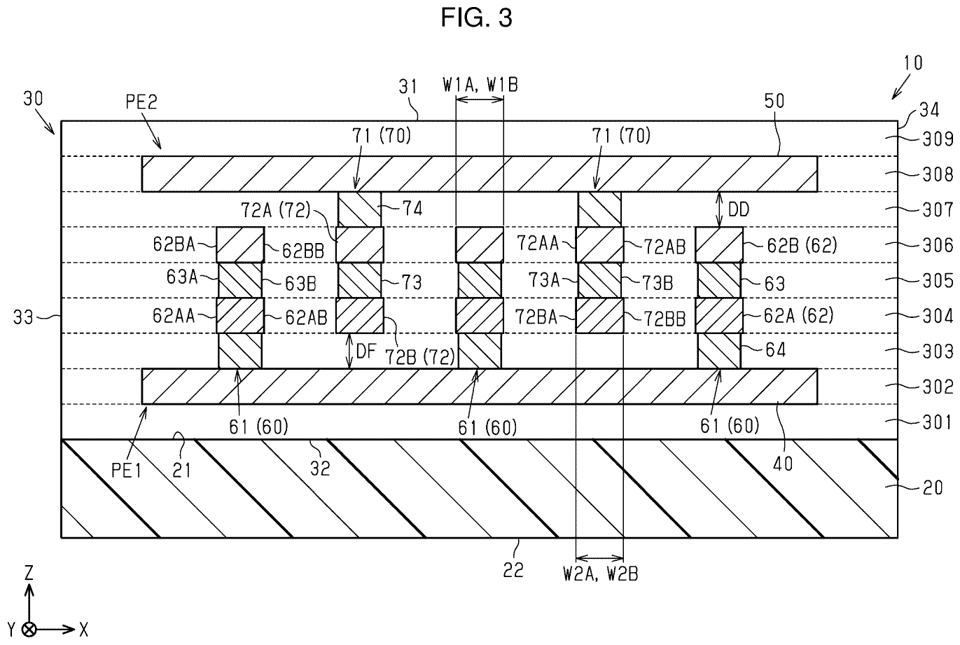

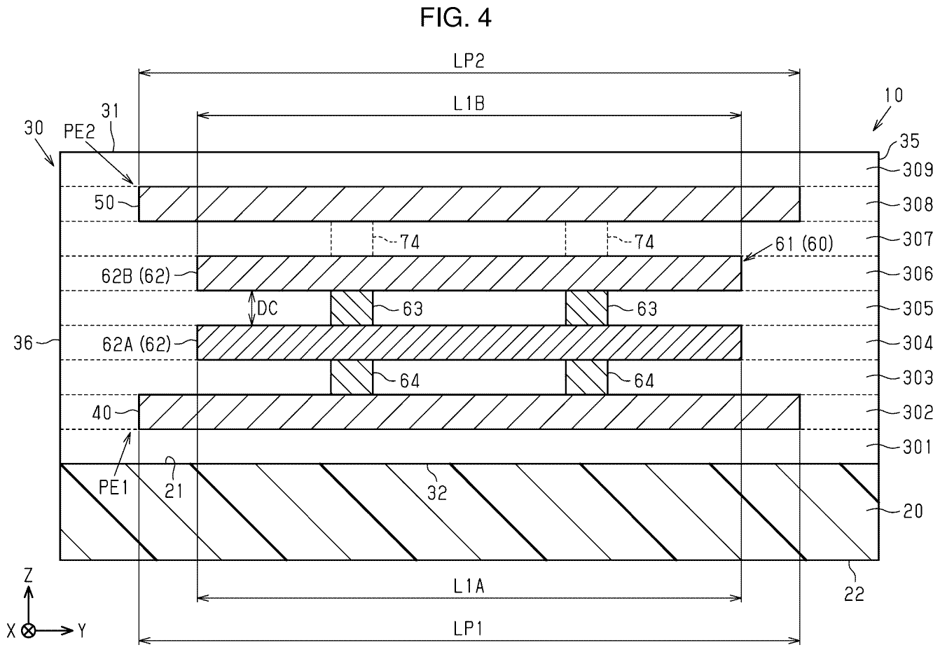

FIG. 1 schematically shows a perspective view structure of the capacitor 10 of Embodiment 1. FIG. 2 schematically shows a plan view structure of the capacitor 10 of FIG. 1. FIG. 3 schematically shows a cross-sectional structure of the capacitor 10 along the F3-F3 line of FIG. 2. FIG. 4 schematically shows a cross-sectional structure of the capacitor 10 along the F4-F4 line of FIG. 2.

As shown in FIG. 1, the capacitor 10 has a substantially rectangular cuboid shape with the Z direction as the thickness direction. The capacitor 10 includes a semiconductor substrate 20. The semiconductor substrate 20 has a plate shape with the Z direction as the thickness direction. The semiconductor substrate 20 includes a first substrate surface 21, and a second substrate surface 22 opposite to the first substrate surface 21. Here, for case of explanation, the two directions perpendicular to each other, among the directions perpendicular to the Z direction, are referred to as the “X direction” and the “Y direction.” A view of the capacitor 10 from the Z direction is referred to as a “plan view.” The X direction is an example of the “first direction,” and the Y direction is an example of the “second direction.” Also, the semiconductor substrate 20 is one example of a “substrate.”

The semiconductor substrate 20 may be made of a material including silicon (Si). In one example, the semiconductor substrate 20 may be a silicon substrate. The semiconductor substrate 20 may include an impurity. The impurity may be a p-type impurity. In one example, the semiconductor substrate 20 may be a silicon substrate including the p-type impurity. The p-type impurity may be boron (B), aluminum (Al), or the like, for example. The resistivity of the semiconductor substrate 20 can be set to 5 mΩ·cm to 100 mΩ·cm, inclusive, by the introduction of the p-type impurity.

The capacitor 10 includes an insulating layer 30 provided over the first substrate surface 21 of the semiconductor substrate 20. The insulating layer 30 is provided over the entirety of the first substrate surface 21, for example. The capacitor 10 has a plate shape with the Z direction as the thickness direction. The insulating layer 30 includes a first surface 31, a second surface 32 opposite to the first surface 31, and first to fourth side faces 33 to 36 that constitute four side faces that connect the first surface 31 and the second surface 32. The second surface 32 is the surface of the insulating layer 30 towards the semiconductor substrate 20. In one example, the second surface 32 is in contact with the first substrate surface 21 of the semiconductor substrate 20. The first side face 33 and the second side face 34 constitute two edge faces of the insulating layer 30 in the X direction. The third side face 35 and the fourth side face 36 constitute two edge faces of the insulating layer 30 in the Y direction.

The insulating layer 30 is electrically insulating. The insulating layer 30 may be made of an oxide film. In one example, the insulating layer 30 is made of a material including at least one of silicon oxide (SiO₂), silicon nitride (SiN), silicon oxynitride (SiON), and aluminum oxide (Al₂O₃). In one example, the insulating layer 30 is made of silicon oxide. As shown in FIG. 3, in one example, the insulating layer 30 may have a structure in which a plurality of insulating films (insulating films 301 to 309 in Embodiment 1) are stacked in the Z direction. The insulating film 301 constitutes the second surface 32 of the insulating layer 30. The insulating film 309 constitutes the first surface 31 of the insulating layer 30. The insulating films 301 to 309 are stacked in sequence from the second surface 32 to the first surface 31 of the insulating layer 30. In one example, the insulating films 301 to 309 have the same thickness (Z direction dimension) as each other.

As shown in FIG. 1, the capacitor 10 includes a first electrode PE1 and a second electrode PE2 that are opposite to each other. The insulating layer 30 is interposed between the first electrode PE1 and the second electrode PE2, which are opposite to each other. In other words, the first electrode PE1 and the second electrode PE2 oppose each other via the insulating layer 30. The first electrode PE1 includes a first electrode plate 40 and a plurality of first electrode parts 60. The second electrode PE2 includes a second electrode plate 50 and a plurality of second electrode parts 70.

The first electrode plate 40 and the second electrode plate 50 are provided in the insulating layer 30. The first electrode plate 40 and the second electrode plate 50 are disposed so as to be separated from each other in the Z direction. The first electrode plate 40 is provided towards the first substrate surface 21 of the semiconductor substrate 20 within the insulating layer 30. The first electrode plate 40 opposes the first substrate surface 21. The second electrode plate 50 is provided across the first electrode plate 40 from the first substrate surface 21 within the insulating layer 30. The second electrode plate 50 opposes the first electrode plate 40 in the Z direction. The insulating layer 30 is interposed between the first electrode plate 40 and the second electrode plate 50 in the Z direction.

As shown in FIG. 3, the first electrode plate 40 and the second electrode plate 50 are respectively provided in each insulating film. In one example, the first electrode plate 40 may be provided in the insulating film 302. In other words, the first electrode plate 40 may be disposed so as to be separated from the semiconductor substrate 20 in the Z direction. In one example, the second electrode plate 50 may be provided in the insulating film 308. In other words, the second electrode plate 50 need not be exposed through the first surface 31 of the insulating layer 30. Thus, the first electrode plate 40 and the second electrode plate 50 may be embedded in the insulating layer 30. The insulating films 303 to 307 are interposed between the first electrode plate 40 and the second electrode plate 50 in the Z direction. The first electrode plate 40 may be electrically connected to the semiconductor substrate 20. In one example, the first electrode plate 40 may be connected to the semiconductor substrate 20 by a connection via (not shown). The connection via is made of a metal material. The connection via may be provided in the insulating film 301. By penetrating the insulating film 301 in the Z direction, the connection via is connected to the first electrode plate 40 and the semiconductor substrate 20.

The first electrode plate 40 and the second electrode plate 50 both have a plate shape with the Z direction as the thickness direction. The first electrode plate 40 and the second electrode plate 50 may have a quadrilateral shape in a plan view. In one example, the size of the first electrode plate 40 in a plan view may be equal to the size of the second electrode plate 50 in a plan view. In another example, the thickness of the first electrode plate 40 (Z direction dimension) may be equal to the thickness (Z direction dimension) of the second electrode plate 50.

The plan view shapes of the first electrode plate 40 and the second electrode plate 50 may be arbitrarily modified. Also, the size of the first electrode plate 40 in a plan view may differ from the size of the second electrode plate 50 in a plan view. Additionally, the thickness of the first electrode plate 40 may differ from the thickness of the second electrode plate 50.

The first electrode plate 40 and the second electrode plate 50 may be made of a single metal layer or have a laminate structure with a plurality of different metal layers. In one example, the material constituting the first electrode plate 40 may be the same as the material constituting the second electrode plate 50.

The first electrode plate 40 and the second electrode plate 50 may include at least one of copper (Cu), aluminum, an aluminum alloy, a copper alloy, tungsten (W), molybdenum (Mo), nickel (Ni), titanium (Ti), titanium nitride (TiN), tantalum (Ta), and tantalum nitride (TaN), for example. In one example, the first electrode plate 40 and the second electrode plate 50 may both be made of a material including at least one of aluminum and copper. In Embodiment 1, the first electrode plate 40 and the second electrode plate 50 are made of a material including aluminum. The material constituting the first electrode plate 40 may differ from the material constituting the second electrode plate 50.

The first electrode parts 60 and the second electrode parts 70 are disposed between the first electrode plate 40 and the second electrode plate 50. The plurality of first electrode parts 60 and the plurality of second electrode parts 70 are disposed alternately in the X direction and oppose each other in the X direction. In Embodiment 1, the plurality of first electrode parts 60 and the plurality of second electrode parts 70 are arrayed so as to alternate one each in the X direction. In one example, in a state where the plurality of first electrode parts 60 and the plurality of second electrode parts 70 are arrayed in the X direction, the electrode part closest to the first side face 33 of the insulating layer 30 is a first electrode part 60, and the electrode part closest to the second side face 34 of the insulating layer 30 is also a first electrode part 60. The arrangement form of the plurality of first electrode parts 60 and the plurality of second electrode parts 70 can be arbitrarily modified. In other words, the electrode part closest to the first side face 33 of the insulating layer 30 may be a second electrode part 70, and the electrode part closest to the second side face 34 of the insulating layer 30 may also be a second electrode part 70.

As shown in FIG. 2, the plurality of first electrode parts 60 may be disposed within a range overlapping the second electrode plate 50 in a plan view. The plurality of second electrode parts 70 may be disposed within a range overlapping the second electrode plate 50 in a plan view. Although not shown, the second electrode plate 50 and the plurality of first electrode parts 70 may be disposed within a range overlapping the first electrode plate 40 in a plan view. Although not shown, the plurality of first electrode parts 60 may be disposed within a range overlapping the first electrode plate 40 in a plan view.

As shown in FIG. 2, an arrangement pitch P1 for the plurality of first electrode parts 60 in the X direction is equal to an arrangement pitch P2 for the plurality of second electrode parts 70 in the X direction. Thus, a distance DA in a plan view between a first electrode part 60 and a second electrode part 70 adjacent to one side of the first electrode part 60 in the X direction is equal to a distance DB in a plan view between the first electrode part 60 and a second electrode part 70 adjacent to the other side of the first electrode part 60 in the X direction.

The distance DA and the distance DB may be changed according to the required withstand voltage of the capacitor 10. The distances DA and DB would be increased as the required withstand voltage of the capacitor 10 increases. In one example, if the required withstand voltage of the capacitor 10 is 40V, then the distances DA and DB would be 0.28 μm. In one example, if the required withstand voltage of the capacitor 10 is 80V, then the distances DA and DB would be 0.46 μm. In one example, if the required withstand voltage of the capacitor 10 is 130V, then the distances DA and DB would be 0.76 μm. In one example, if the required withstand voltage of the capacitor 10 is 200V, then the distances DA and DB would be 1.06 μm. Here, the distance DA can be defined by the minimum distance in a plan view between the first electrode part 60 and the second electrode part 70 adjacent to one side of the first electrode part 60 in the X direction. The distance DB can be defined by the minimum distance in a plan view between the first electrode part 60 and the second electrode part 70 adjacent to the other side of the first electrode part 60 in the X direction.

As shown in FIGS. 3 and 4, each first electrode part 60 is electrically connected to the first electrode plate 40. Each first electrode part 60 is constituted of a plurality of first conductive layers 61 that are stacked from the first electrode plate 40 towards the second electrode plate 50. Each first electrode part 60 is provided from the insulating film 303 to the insulating film 306 in the Z direction. The plurality of first conductive layers 61 are in contact the first electrode plate 40 in the Z direction. On the other hand, the plurality of first conductive layers 61 are separated from the second electrode plate 50 in the Z direction. The insulating layer 30 (insulating film 307) is interposed between the plurality of first conductive layers 61 and the second electrode plate 50 in the Z direction.

Each first conductive layer 61 may include a plurality of first wiring lines 62, a first via 63, and a first electrode via 64. In one example, a plurality of the first vias 63 may be provided. In one example, a plurality of the first electrode vias 64 may be provided.

The plurality of first wiring lines 62 are arrayed in the Z direction. The plurality of first wiring lines 62 are arrayed so as to be separated from each other in the Z direction. Each first wiring line 62 extends in the Y direction in a plan view. One of the plurality of first wiring lines 62 is provided in the insulating film 304. Another of the plurality of first wiring lines 62 is provided in the insulating film 306. Below, the first wiring line 62 provided in the insulating film 304 is referred to as the “first wiring line 62A,” and the first wiring line 62 provided in the insulating film 306 is referred to as the “first wiring line 62B.”

The first wiring lines 62A and 62B are disposed at overlapping positions in a plan view. A width W1A of the first wiring line 62A may be equal to a width W1B of the first wiring line 62B. A length L1A of the first wiring line 62A may be equal to a length L1B of the first wiring line 62B. The length L1A of the first wiring line 62A and the length L1B of the first wiring line 62B are shorter than a length LP1 of the first electrode plate 40 in the Y direction. The length L1A of the first wiring line 62A and the length L1B of the first wiring line 62B are shorter than a length LP2 of the second electrode plate 50 in the Y direction. The first wiring line 62B opposes the second electrode plate 50 in the Z direction. More specifically, the first wiring line 62B is disposed across the insulating film 307 from the second electrode plate 50. Thus, a distance DC in the Z direction between the first wiring line 62A and the first wiring line 62B (see FIG. 4) may be equal to a distance DD in the Z direction between the first wiring line 62B and the second electrode plate 50 (see FIG. 3).

The first wiring line 62A includes wiring line side faces 62AA and 62AB constituting both edge faces in the X direction. The wiring line side faces 62AA and 62AB are configured along the YZ plane, for example. The wiring line side faces 62AA and 62AB have a rectangular shape where the Y direction is the long side and the Z direction is the short side, as viewed from the X direction.

The first wiring line 62B includes wiring line side faces 62BA and 62BB constituting both edge faces in the X direction. The wiring line side faces 62BA and 62BB are configured along the YZ plane, for example. The wiring line side faces 62BA and 62BB have a rectangular shape where the Y direction is the long side and the Z direction is the short side, as viewed from the X direction.

Each first via 63 electrically connects first wiring lines 62A and 62B that are adjacent to each other in the Z direction. In other words, the first wiring lines 62A and 62B that are adjacent to each other in the Z direction are electrically connected by the plurality of first vias 63. The plurality of first vias 63 are arranged so as to be separated from each other in the Y direction. Each first via 63 is provided in the insulating film 305.

Each first via 63 may be a quadrilateral prism. Thus, each first via 63 includes via side faces 63A and 63B constituting both edge faces in the X direction. The via side faces 63A and 63B are configured along the YZ plane, for example. In Embodiment 1, each first via 63 is provided such that the length thereof (Y direction dimension) is greater than the thickness thereof (Z direction dimension). Thus, the via side faces 63A and 63B have a rectangular shape where the Y direction is the long side and the Z direction is the short side, as viewed from the X direction. In Embodiment 1, the Y direction dimension of the via side faces 63A and 63B is less than 1.5 times the Z direction dimension of the via side faces 63A and 63B.

Each first electrode via 64 connects, to the first electrode plate 40, the first wiring line 62A, among the plurality of first wiring lines 62A and 62B, closest to the first electrode plate 40. The first wiring line 62A and the first electrode plate 40 are electrically connected by the plurality of first electrode vias 64. In one example, the plurality of first electrode vias 64 may be disposed at positions overlapping the plurality of first vias 63 in a plan view. Each first electrode via 64 is disposed further towards the first electrode plate 40 than each second electrode part 70 in the Z direction.

The first wiring lines 62A and 62B, the first vias 63, and the first electrode vias 64 may be made of a single metal layer or have a laminate structure with a plurality of different metal layers. The first wiring lines 62A and 62B, the first vias 63, and the first electrode vias 64 may include at least one of copper, aluminum, an aluminum alloy, a copper alloy, tungsten, molybdenum, nickel, titanium, titanium nitride, tantalum, and tantalum nitride, for example. In one example, the first wiring lines 62A and 62B may both be made of a material including at least one of aluminum and copper. In Embodiment 1, the first wiring lines 62A and 62B are made of a material including aluminum. In other words, the first electrode plate 40, the second electrode plate 50, and the first wiring lines 62A and 62B may be made of the same material. In one example, the first vias 63 may both be made of a material including tungsten. In other words, the first vias 63 may be made of a material differing from that of the first wiring lines 62A and 62B. In one example, the first electrode vias 64 may be made of a material including tungsten. In other words, the first electrode vias 64 may be made of a material differing from that of the first wiring lines 62A and 62B. Also, the first electrode vias 64 may be made of the same material as the first vias 63.

The material constituting the first wiring lines 62A and 62B may differ from the material constituting the first electrode plate 40 and the second electrode plate 50. Also, the material forming the first wiring line 62A may differ from the material constituting the first wiring line 62B. Additionally, the first electrode vias 64 may be made of a material differing from that of the first vias 63. Also, the first wiring lines 62A and 62B, the first vias 63, and the first electrode vias 64 may be made of the same material as each other.

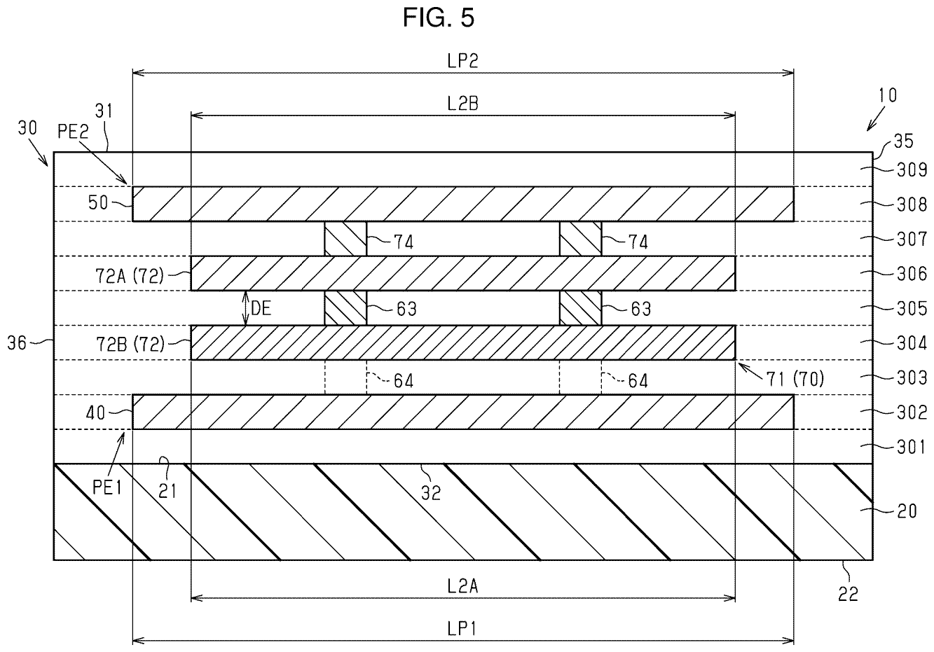

As shown in FIGS. 3 and 5, each second electrode part 70 is electrically connected to the second electrode plate 50. Each second electrode part 70 is constituted of a plurality of second conductive layers 71 that are stacked from the second electrode plate 50 towards the first electrode plate 40. Each second electrode part 70 is provided from the insulating film 307 to the insulating film 304 in the Z direction. The plurality of second conductive layers 71 contact the second electrode plate 50 in the Z direction. On the other hand, the plurality of second conductive layers 71 are separated from the first electrode plate 40 in the Z direction. The insulating layer 30 (insulating film 303) is interposed between the second conductive layer 71 and the first electrode plate 40 in the Z direction.

Each second conductive layer 71 may include a plurality of second wiring lines 72, a second via 73, and a second electrode via 74. In one example, a plurality of the second vias 73 may be provided. In one example, a plurality of the second electrode vias 74 may be provided.

The plurality of second wiring lines 72 are arrayed in the Z direction. The plurality of second wiring lines 72 are arrayed so as to be separated from each other in the Z direction. Each second wiring line 72 extends in the Y direction in a plan view. One of the plurality of second wiring lines 72 is provided in the insulating film 304. Another of the plurality of second wiring lines 72 is provided in the insulating film 306. Below, the second wiring line 72 provided in the insulating film 306 is referred to as the “second wiring line 72A,” and the second wiring line 72 provided in the insulating film 304 is referred to as the “second wiring line 72B.”

The second wiring line 72A is provided in the same position as the first wiring line 62B in the Z direction. The second wiring line 72B is provided in the same position as the first wiring line 62A in the Z direction. The second wiring lines 72A and 72B are disposed at overlapping positions in a plan view.

A width W2A of the second wiring line 72A may be equal to a width W2B of the second wiring line 72B. The widths W2A and W2B of the second wiring lines 72A may be equal to the widths W1A and W1B of the first wiring lines 62A and 62B. A length L2A of the second wiring line 72A may be equal to a length L2B of the second wiring line 72B. The lengths L2A and L2B of the second wiring lines 72A and 72B may be equal to the lengths L1A and L1B of the first wiring lines 62A and 62B.

The second wiring line 72A includes wiring line side faces 72AA and 72AB

constituting both edge faces in the X direction. The wiring line side faces 72AA and 72AB are configured along the YZ plane, for example. The wiring line side faces 72AA and 72AB have a rectangular shape where the Y direction is the long side and the Z direction is the short side, as viewed from the X direction.

The second wiring line 72B includes wiring line side faces 72BA and 72BB constituting both edge faces in the X direction. The wiring line side faces 72BA and 72BB are configured along the YZ plane, for example. The wiring line side faces 72BA and 72BB have a rectangular shape where the Y direction is the long side and the Z direction is the short side, as viewed from the X direction.

If the lengths L2A and L2B of the second wiring lines 72A and 72B are equal to the lengths L1A and L1B of the first wiring lines 62A and 62B (see FIG. 4), then the areas of the wiring line side faces 72AA and 72AB are equal to the areas of the wiring line side faces 62BA and 62BB of the first wiring line 62B, and the areas of the wiring line side faces 72BA and 72BB are equal to the areas of the wiring line side faces 62AA and 62AB of the first wiring line 62A.

The second wiring line 72A opposes the first wiring line 62B in the X direction. More specifically, the wiring line side face 72AA of the second wiring line 72A opposes the wiring line side face 62BB of the first wiring line 62B in the X direction. The wiring line side faces 72AA and 62BB are both along the YZ plane, and thus, the distance between the wiring line side face 72AA and the wiring line side face 62BB in the X direction is constant throughout the entire length of the wiring line side faces 72AA and 62BB in the Y direction, and is constant throughout the entire width of the wiring line side faces 72AA and 62BB in the Z direction. Also, the wiring line side face 72AB of the second wiring line 72A opposes the wiring line side face 62BA of another first wiring line 62B in the X direction. More specifically, the wiring line side face 72AB of the second wiring line 72A opposes the wiring line side face 62BA of the other first wiring line 62B in the X direction. The wiring line side faces 72AB and 62BA are both along the YZ plane, and thus, the distance between the wiring line side face 72AB and the wiring line side face 62BA in the X direction is constant throughout the entire length of the wiring line side faces 72AB and 62BA in the Y direction, and is constant throughout the entire width of the wiring line side faces 72AB and 62BA in the Z direction.

The second wiring line 72B opposes the first wiring line 62A in the X direction. More specifically, the wiring line side face 72BA of the second wiring line 72B opposes the wiring line side face 62AB of the first wiring line 62A in the X direction. The wiring line side faces 72BA and 62AB are both along the YZ plane, and thus, the distance between the wiring line side face 72BA and the wiring line side face 62AB in the X direction is constant throughout the entire length of the wiring line side faces 72BA and 62AB in the Y direction, and is constant throughout the entire width of the wiring line side faces 72BA and 62AB in the Z direction. Also, the wiring line side face 72BB of the second wiring line 72B opposes the wiring line side face 62AA of another first wiring line 62A in the X direction. More specifically, the wiring line side face 72BB of the second wiring line 72B opposes the wiring line side face 62AA of the other first wiring line 62A in the X direction. The wiring line side faces 72BB and 62AA are both along the YZ plane, and thus, the distance between the wiring line side face 72BB and the wiring line side face 62AA in the X direction is constant throughout the entire length of the wiring line side faces 72BB and 62AA in the Y direction, and is constant throughout the entire width of the wiring line side faces 72BB and 62AA in the Z direction.

The second wiring line 72B opposes the first electrode plate 40 in the Z direction. More specifically, the second wiring line 72B is disposed across the insulating film 303 from the first electrode plate 40. Thus, a distance DE in the Z direction between the second wiring line 72A and the second wiring line 72B (see FIG. 5) may be equal to a distance DF in the Z direction between the second wiring line 72B and the first electrode plate 40 (see FIG. 3). The distance DF may be equal to the distance DD in the Z direction between the first wiring line 62B and the second electrode plate 50.

Each second via 73 electrically connects second wiring lines 72A and 72B that are adjacent to each other in the Z direction. In other words, the second wiring lines 72A and 72B that are adjacent to each other in the Z direction are electrically connected by the plurality of second vias 73. The plurality of second vias 73 are arranged so as to be separated from each other in the Y direction. Each second via 73 is provided in the insulating film 305. In other words, each second via 73 is disposed in the same position as each first via 63 in the Z direction. In one example, the plurality of second vias 73 may be equal in size to each other. In one example, the size of the plurality of second vias 73 may be equal to the size of the plurality of first vias 63.

Each second via 73 may be a quadrilateral prism. Thus, each second via 73 includes via side faces 73A and 73B constituting both edge faces in the X direction. The via side faces 73A and 73B are configured along the YZ plane, for example. In Embodiment 1, each second via 73 is provided such that the length thereof (Y direction dimension) is greater than the thickness thereof (Z direction dimension). Thus, the via side faces 73A and 73B have a rectangular shape where the Y direction is the long side and the Z direction is the short side, as viewed from the X direction. In Embodiment 1, the Y direction dimension of the via side faces 73A and 73B is less than 1.5 times the Z direction dimension of the via side faces 73A and 73B. The length of the second via 73 (Y direction dimension) may be equal to the length (Y direction dimension) of the first via 63.

The plurality of second vias 73 may oppose the corresponding plurality of first vias 63 in the X direction. More specifically, the via side face 73A of the second via 73 may oppose the via side face 63B of the first via 63 in the X direction. The via side faces 73A and 63B are both along the YZ plane, and thus, the distance between the via side face 73A and the via side face 63B in the X direction is constant throughout the entire length of the via side faces 73A and 63B in the Y direction, and is constant throughout the entire width of the via side faces 73A and 63B in the Z direction. Also, the via side face 73B of the second via 73 opposes the via side face 63A of another first via 63 in the X direction. More specifically, the via side face 73B of the second via 73 opposes the via side face 63A of the other first via 63 in the X direction. The via side faces 73B and 63A are both along the YZ plane, and thus, the distance between the via side face 73B and the via side face 63A in the X direction is constant throughout the entire length of the via side faces 73B and 63A in the Y direction, and is constant throughout the entire width of the via side faces 73B and 63A in the Z direction.

Each second electrode via 74 connects, to the second electrode plate 50, the second wiring line 72A, among the plurality of second wiring lines 72A and 72B, closest to the second electrode plate 50. The second wiring line 72A and the second electrode plate 50 are electrically connected by the plurality of second electrode vias 74. In one example, the plurality of second electrode vias 74 may be disposed at positions overlapping the plurality of second vias 73 in a plan view. In Embodiment 1, each second electrode via 74 is provided in the insulating film 307. Thus, each second electrode via 74 is provided further towards the second electrode plate 50 than the first electrode parts 60 in the Z direction.

The second wiring lines 72A and 72B, the second vias 73, and the second electrode vias 74 may be made of a single metal layer or have a laminate structure with a plurality of different metal layers. The second wiring lines 72A and 72B, the second vias 73, and the second electrode vias 74 may include at least one of copper, aluminum, an aluminum alloy, a copper alloy, tungsten, molybdenum, nickel, titanium, titanium nitride, tantalum, and tantalum nitride, for example. In one example, the second wiring lines 72A and 72B may both be made of a material including at least one of aluminum and copper. In Embodiment 1, the second wiring lines 72A and 72B are made of a material including aluminum. In other words, the first electrode plate 40, the second electrode plate 50, the first wiring lines 62A and 62B, and the second wiring lines 72A and 72B may be made of the same material. In one example, the second vias 73 may both be made of a material including tungsten. In other words, the second vias 73 may be made of a material differing from that of the second wiring lines 72A and 72B. The second vias 73 may be made of the same material as the first vias 63. In one example, the second electrode vias 74 may be made of a material including tungsten. In other words, the second electrode vias 74 may be made of a material differing from that of the second wiring lines 72A and 72B. Also, the second electrode vias 74 may be made of the same material as the second vias 73. The second electrode vias 74 may be made of the same material as the first electrode vias 64.

The material constituting the second wiring lines 72A and 72B may differ from the material constituting the first electrode plate 40 and the second electrode plate 50. Also, the material forming the second wiring line 72A may differ from the material constituting the second wiring line 72B. Additionally, the second electrode vias 74 may be made of a material differing from that of the second vias 73. Also, the second wiring lines 72A and 72B, the second vias 73, and the second electrode vias 74 may be made of the same material as each other.

The capacitor 10 is constituted of the first electrode parts 60, the second electrode parts 70, and the insulating layer 30 between the first electrode parts 60 and the second electrode parts 70 in the X direction. More specifically, a portion of the capacitor is constituted of the first wiring line 62A, the second wiring line 72B, and the insulating layer 30 between the first wiring line 62A and the second wiring line 72B in the X direction. A portion of the capacitor is constituted of the first wiring line 62B, the second wiring line 72A, and the insulating layer 30 between the first wiring line 62B and the second wiring line 72A in the X direction. A portion of the capacitor is constituted of the plurality of first vias 63, the plurality of second vias 73, and the insulating layer 30 between the plurality of first vias 63 and the plurality of second vias 73 in the X direction. A portion of the capacitor is constituted of the first wiring line 62B, the second electrode plate 50, and the insulating layer 30 between the first wiring line 62B and the second electrode plate 50 in the Z direction. A portion of the capacitor is constituted of the second wiring line 72B, the first electrode plate 40, and the insulating layer 30 between the second wiring line 72B and the first electrode plate 40 in the X direction.

### Operation of Embodiment 1

The operation of the capacitor 10 of Embodiment 1 will be described.

The parasitic capacitance between the second electrode and the semiconductor substrate of the capacitor (hereinafter referred to as the “parasitic capacitance Cts”) increases if the second wiring lines of the second electrode parts and the semiconductor substrate oppose each other with only the insulating layer therebetween (hereinafter referred to as the “comparison configuration”). In other words, the parasitic capacitance Cts increases if the second wiring lines of the second electrode parts and the semiconductor substrate face each other directly without other conductive layers between the second wiring lines and the semiconductor substrate.

By comparison, in the capacitor 10 of Embodiment 1, the first electrode plate 40 is interposed between the second electrode parts 70 and the semiconductor substrate 20 in the Z direction, and thus, a portion of the capacitor is formed between the second electrode parts 70 and the first electrode plate 40, and a parasitic capacitance is less susceptible to form between the second electrode parts 70 and the semiconductor substrate 20. Thus, the parasitic capacitance Cts between the second electrode PE2 and the semiconductor substrate 20 is reduced.

### Effects of Embodiment 1

The following effects can be attained by the capacitor 10 of Embodiment 1.
(1-1) The capacitor 10 includes the semiconductor substrate 20 including the first substrate surface 21, the insulating layer 30 provided over the first substrate surface 21, and the first electrode PE1 and the second electrode PE2 that are provided in the insulating layer 30 and oppose each other. The first electrode PE1 includes a first electrode plate 40 and a plurality of first electrode parts 60. The second electrode PE2 includes a second electrode plate 50 and a plurality of second electrode parts 70. The first electrode plate 40 is provided towards the first substrate surface 21 within the insulating layer 30, and opposes the first substrate surface 21. The second electrode plate 50 is provided across the first electrode plate 40 from the first substrate surface 21 within the insulating layer 30 so as to oppose the first electrode plate 40. The plurality of first electrode parts 60 are disposed between the first electrode plate 40 and the second electrode plate 50, and are electrically connected to the first electrode plate 40. The plurality of second electrode parts 70 are disposed between the second electrode plate 50 and the first electrode plate 40, and are electrically connected to the second electrode plate 50. The plurality of first electrode parts 60 and the plurality of second electrode parts 70 are disposed alternately in the X direction, which is the first direction perpendicular to the thickness direction of the semiconductor substrate 20, and oppose each other in the X direction. The first electrode plate 40 is interposed between the plurality of second electrode parts 70 and the semiconductor substrate 20.

According to this configuration, the plurality of second electrode parts 70 are provided between the first electrode plate 40 and the second electrode plate 50 in the Z direction, and thus, the first electrode plate 40 is interposed between the plurality of second electrode parts 70 and the semiconductor substrate 20 in the Z direction. As a result, the plurality of second electrode parts 70 and the semiconductor substrate 20 are prevented from directly opposing each other, and therefore, a parasitic capacitance is less susceptible to forming between the plurality of second electrode parts 70 and the semiconductor substrate 20. Thus, the parasitic capacitance Cts between the second electrode PE2 and the semiconductor substrate 20 can be reduced.
(1-2) Each first electrode part 60 is constituted of the plurality of first conductive layers 61 that are stacked from the first electrode plate 40 towards the second electrode plate 50. Each second electrode part 70 is constituted of a plurality of second conductive layers 71 that are stacked from the second electrode plate 50 towards the first electrode plate 40.

According to this configuration, the opposing area of the first electrode parts 60 and the second electrode parts 70 is increased compared to a case where the first electrode parts 60 are constituted of one first conductive layer 61 and the second electrode parts 70 are constituted of one second conductive layer 71. Thus, the capacitance of the capacitor 10 can be increased. Furthermore, assuming the capacitances of the capacitors are equal, the number of first electrode parts 60 and second electrode parts 70 can be reduced compared to a case where the first electrode part 60 is constituted of one first conductive layer 61 and the second electrode part 70 is constituted of one second conductive layer 71. Thus, the size of the capacitor 10 can be reduced.
(1-3) The plurality of first conductive layers 61 include the plurality of first wiring lines 62A and 62B arrayed in the Z direction, first vias 63 that electrically connect first wiring lines 62A and 62B that are adjacent to each other in the Z direction, and first electrode vias 64 that connect the first electrode plate 40 to the first wiring line 62A closest to the first electrode plate 40 among the plurality of first wiring lines 62A and 62B. The plurality of second conductive layers 71 include the plurality of second wiring lines 72A and 72B arrayed in the Z direction, second vias 73 that electrically connect second wiring lines 72A and 72B that are adjacent to each other in the Z direction, and second electrode vias 74 that connect the second electrode plate 50 to the second wiring line 72A closest to the second electrode plate 50 among the plurality of second wiring lines 72A and 72B.

According to this configuration, the plurality of first conductive layers 61 are constituted of a laminate structure of wiring lines and vias, and thus, it is possible to form with case the plurality of first conductive layers 61 stacked from the first electrode plate 40 towards the second electrode plate 50. The plurality of second conductive layers 71 are constituted of a laminate structure of wiring lines and vias, and thus, the plurality of second conductive layers 71 that are stacked from the second electrode plate 50 towards the first electrode plate 40 can be formed with ease.
(1-4) Each of the plurality of first wiring lines 62A and 62B extends in the Y direction, which is the second direction that is perpendicular to the X direction, in a plan view. The first wiring lines 62A and 62B that are adjacent to each other in the Z direction are electrically connected by the plurality of first vias 63. The plurality of second wiring lines 72A and 72B extend in the Y direction. The second wiring lines 72A and 72B that are adjacent to each other in the Z direction are electrically connected by the plurality of second vias 73.

According to this configuration, the electrical resistance of the plurality of first conductive layers 61 can be reduced compared to a case in which only one first via 63 is provided. The electrical resistance of the plurality of second conductive layers 71 can be reduced compared to a case in which only one second via 73 is provided. Thus, heat generation in the capacitor 10 can be reduced.
(1-5) The plurality of first wiring lines 62A and 62B and the plurality of second wiring lines 72A and 72B oppose each other in the X direction.

According to this configuration, a capacitor is formed as a result of the first wiring lines 62A and 62B and the second wiring lines 72A and 72B opposing each other in the X direction. Additionally, the opposing area of the first wiring lines 62A and 62B and the second wiring lines 72A and 72B is greater than a case in which the first wiring lines 62A and 62B and the second wiring lines 72A and 72B oppose each other in the Y direction. As a result, the opposing area of the first electrode parts 60 and the second electrode parts 70 is increased. Thus, the capacitance of the capacitor 10 can be increased. Furthermore, assuming the capacitances of the capacitors are equal, the number of first electrode parts 60 and second electrode parts 70 can be reduced compared to a case in which the first wiring lines 62A and 62B and the second wiring lines 72A and 72B do not oppose each other in the X direction. Thus, the size of the capacitor 10 can be reduced.
(1-6) The Y direction lengths L1A and L1B of the plurality of first wiring lines 62A and 62B are equal to the Y direction lengths L2A and L2B of the second wiring lines 72A and 72B.

According to the configuration, it is possible to increase the opposing area between the plurality of first wiring lines 62A and 62B and the plurality of second wiring lines 72A and 72B without excessively increasing the Y direction dimension of the capacitor 10.
(1-7) Each of the plurality of first vias 63 opposes each of the plurality of second vias 73 in the X direction.

According to this configuration, compared to a configuration in which there is one each of the first via 63 and the second via 73, the opposing area of the first electrode parts 60 and the second electrode parts 70 in the X direction is increased. Thus, the capacitance of the capacitor 10 can be increased. Furthermore, assuming the capacitances of the capacitors are equal, the number of first electrode parts 60 and second electrode parts 70 can be reduced compared to a case in which there is one each of the first via 63 and the second via 73. Thus, the size of the capacitor 10 can be reduced.
(1-8) The second wiring line 72A (72B) is disposed in the X direction center between two first wiring lines 62A (62B) that are adjacent to each other in the X direction.

According to this configuration, it is possible to reduce variation in the distance between the second wiring lines 72A (72B) and the first wiring lines 62A (62B), and thus, it is possible to mitigate a reduction in withstand voltage of the capacitor 10 resulting from an excessive reduction in distance between the second wiring lines 72A (72B) and the first wiring lines 62A (62B).
(1-9) The insulating layer 30 may be made of a material including SiO₂.

According to this configuration, it is possible to mitigate a decrease in withstand voltage of the capacitor 10 compared to a case in which the insulating layer 30 is made of an insulating material such as silicon nitride having a relative permittivity higher than SiO₂, for example.
(1-10) The second electrode plate 50 opposes each of the plurality of first electrode parts 60 while being positioned farther to the opposite side to the first substrate surface 21 of the semiconductor substrate 20 as compared to the plurality of first electrode parts 60 in the Z direction.

According to this configuration, it is possible to form a portion of the capacitor between the second electrode plate 50 and the plurality of first electrode parts 60, and thus, it is possible to further increase the capacitance of the capacitor 10. Furthermore, assuming the capacitances of the capacitors are equal, the number of first electrode parts 60 and second electrode parts 70 can be reduced compared to a case in which the second electrode plate 50 and the plurality of first electrode parts 60 do not oppose each other. Thus, the size of the capacitor 10 can be reduced.

### Embodiment 2

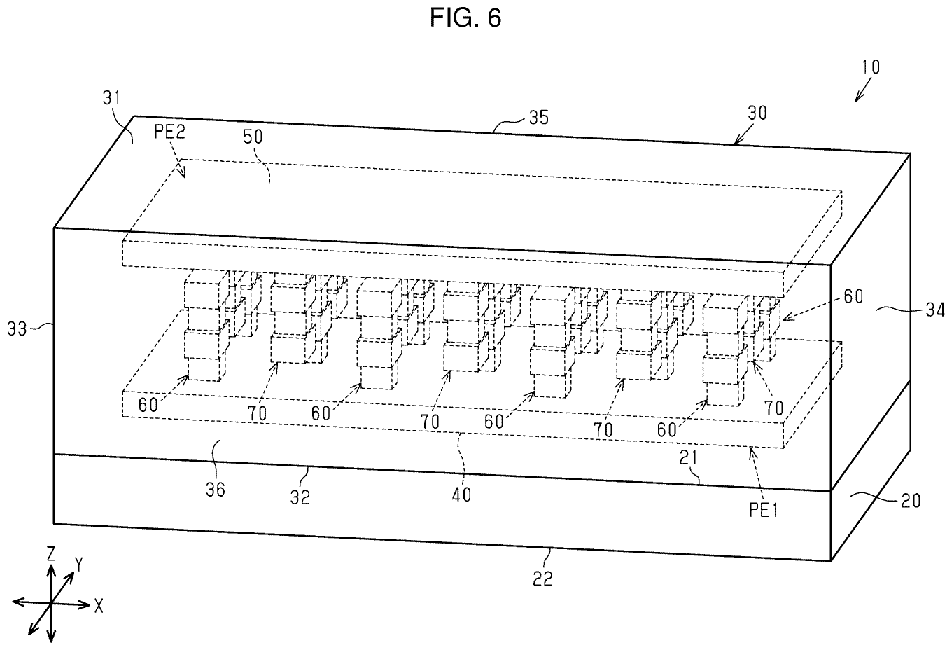

A capacitor 10 according to Embodiment 2 will be described below with reference to FIGS. 6 to 9. The capacitor 10 of Embodiment 2 primarily differs from the capacitor 10 of Embodiment 1 by including first electrode parts 80 and second electrode parts 90 instead of the first electrode parts 60 and the second electrode parts 70. Below, constituent elements in common with those of Embodiment 1 are assigned the same reference characters and descriptions thereof are omitted.

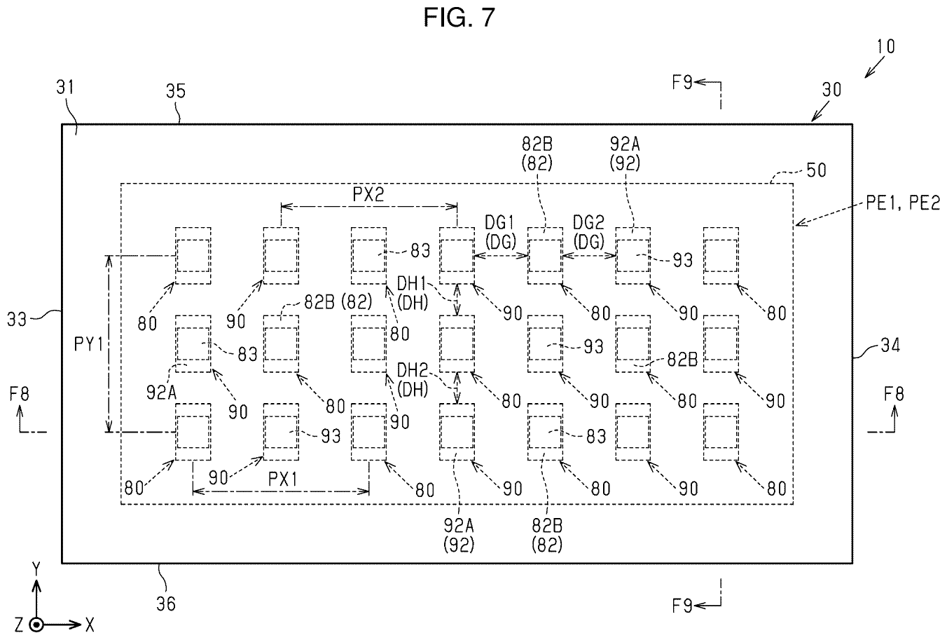

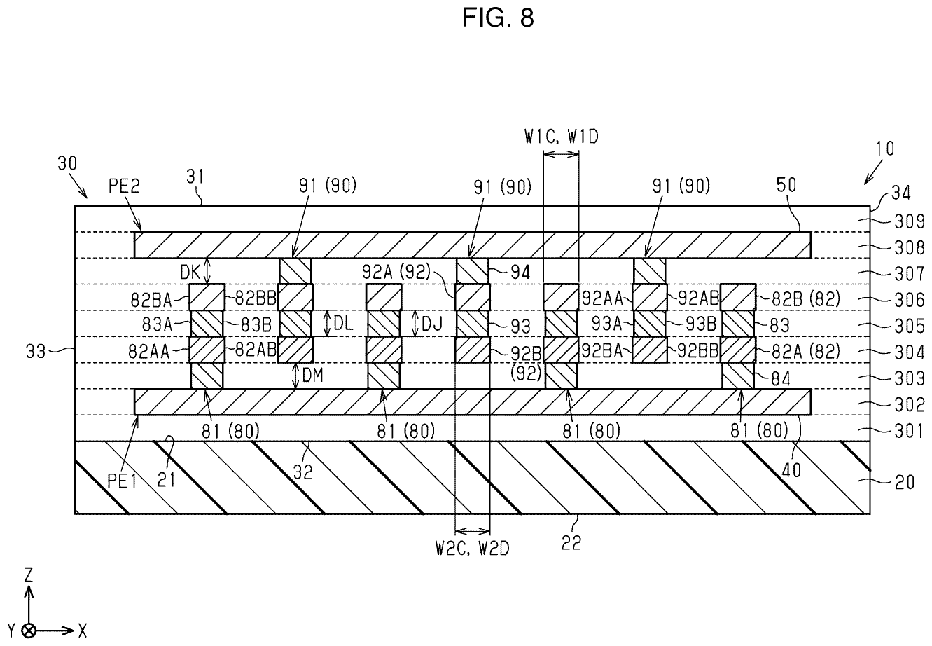

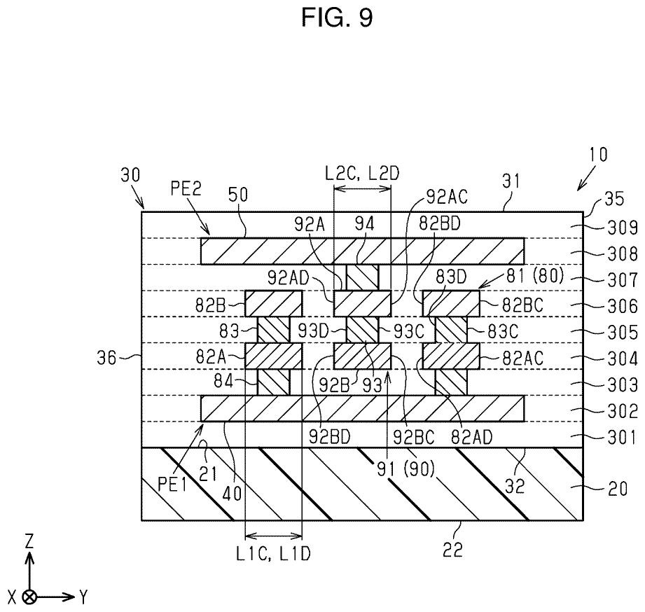

FIG. 6 schematically shows a perspective view structure of the capacitor 10 of Embodiment 2. FIG. 7 schematically shows a plan view structure of the capacitor 10 of FIG. 6. FIG. 8 schematically shows a cross-sectional structure of the capacitor 10 along the F8-F8 line of FIG. 7. FIG. 9 schematically shows a cross-sectional structure of the capacitor 10 along the F9-F9 line of FIG. 7.

As shown in FIGS. 6 to 9, the first electrode PE1 of the capacitor 10 includes a first electrode plate 40 and a plurality of first electrode parts 80. The second electrode PE2 includes a second electrode plate 50 and a plurality of second electrode parts 90. Each of the first electrode parts 80 and each of the second electrode parts 90 are disposed between the first electrode plate 40 and the second electrode plate 50 in the Z direction. Each first electrode part 80 is electrically connected to the first electrode plate 40. Each second electrode part 90 is electrically connected to the second electrode plate 50. In Embodiment 2, the plurality of first electrode parts 80 are arranged so as to be separated from each other in both the X and Y directions. In one example, the plurality of first electrode parts 80 are arranged in a matrix. The plurality of second electrode parts 90 are arranged so as to be separated from each other in both the X and Y directions. In one example, the plurality of second electrode parts 90 are arranged in a matrix.

The plurality of first electrode parts 80 and the plurality of second electrode parts 90 are arrayed alternately in the X direction and oppose each other in the X direction, and are arrayed alternately in the Y direction and oppose each other in the Y direction. In Embodiment 2, the plurality of first electrode parts 80 and the plurality of second electrode parts 90 are arranged so as to alternate one each in the X direction in a plan view. The plurality of first electrode parts 80 and the plurality of second electrode parts 90 are arranged so as to alternate one each in the Y direction in a plan view.

An arrangement pitch PX1 for the plurality of first electrode parts 80 in the X direction may be equal to an arrangement pitch PY1 for the plurality of first electrode parts 80 in the Y direction. In one example, the arrangement pitch PX1 may be equal to an arrangement pitch PX2 for the plurality of second electrode parts 90 in the X direction.

In the example shown in FIG. 6, a distance DG between the first electrode parts 80 and the second electrode parts 90 in the X direction is greater than a distance DH between the first electrode parts 80 and the second electrode parts 90 in the Y direction. In one example, among the distances DG, a distance DG1 between the first electrode parts 80 and the second electrode parts 90 in one direction in the X direction may be equal to a distance DG2 between the first electrode parts 80 and the second electrode parts 90 in another direction in the X direction. In one example, among the distances DH a distance DH1 between the first electrode parts 80 and the second electrode parts 90 in one direction in the Y direction may be equal to a distance DH2 between the first electrode parts 80 and the second electrode parts 90 in another direction in the Y direction.

The relationship between the distances DH and DG can be arbitrarily changed. In one example, the distance DG may be less than the distance DH. In another example, the distance DG may be equal to the distance DH. If the distances DG and DH are equal to each other, then it is possible to dispose the first electrode parts 80 and the second electrode parts 90 at a high density while reducing the withstand voltage of the capacitor 10.

As shown in FIG. 7, the plurality of first electrode parts 80 may be disposed within a range overlapping the second electrode plate 50 in a plan view. The plurality of second electrode parts 90 may be disposed within a range overlapping the second electrode plate 50 in a plan view. Although not shown, the second electrode plate 50 and the plurality of first electrode parts 90 may be disposed within a range overlapping the first electrode plate 40 in a plan view. Although not shown, the plurality of first electrode parts 80 may be disposed within a range overlapping the first electrode plate 40 in a plan view.

As shown in FIGS. 8 and 9, each first electrode part 80 is constituted of a plurality of first conductive layers 81 that are stacked from the first electrode plate 40 towards the second electrode plate 50. The first conductive layer 81 closest to the first electrode plate 40, among the plurality of first conductive layers 81, contacts the first electrode plate 40 in the Z direction. On the other hand, the first conductive layer 81 closest to the second electrode plate 50, among the plurality of first conductive layers 81, is separated from the second electrode plate 50 in the Z direction. The insulating layer 30 (insulating film 307) is interposed between the first conductive layer 81 and the second electrode plate 50 in the Z direction.

The first conductive layer 81 may include a plurality of first wiring lines 82, one first via 83, and one first electrode via 84. The plurality of first wiring lines 82 are arrayed in the Z direction. The plurality of first wiring lines 82 are arrayed so as to be separated from each other in the Z direction. Each first wiring line 82 is a rectangular cuboid with the Y direction dimension being longer than the X direction dimension. One of the plurality of first wiring lines 82 is provided in the insulating film 304. Another of the plurality of first wiring lines 82 is provided in the insulating film 306. Below, the first wiring line 82 provided in the insulating film 304 is referred to as the “first wiring line 82A,” and the first wiring line 82 provided in the insulating film 306 is referred to as the “first wiring line 82B.”

The first wiring lines 82A and 82B are disposed at overlapping positions in a plan view. A width W1C of the first wiring line 82A may be equal to a width W1D of the first wiring line 82B. A length L1C of the first wiring line 82A may be equal to a length L1D of the first wiring line 82B. The first wiring line 82B opposes the second electrode plate 50 in the Z direction. More specifically, the first wiring line 82B is disposed across the insulating film 307 from the second electrode plate 50. Thus, a distance DJ in the Z direction between the first wiring line 82A and the first wiring line 82B may be equal to a distance DK in the Z direction between the first wiring line 82B and the second electrode plate 50.

The first wiring line 82A includes wiring line side faces 82AA and 82AB constituting both edge faces in the X direction, and wiring line side faces 82AC and 82AD constituting both edge faces in the Y direction. The wiring line side faces 82AA and 82AB are configured along the YZ plane, for example. The wiring line side faces 82AC and 82AD are configured along the XZ plane, for example. The wiring line side faces 82AA and 82AB have a rectangular shape where the Y direction is the long side and the Z direction is the short side, as viewed from the X direction. The wiring line side faces 82AC and 82AD have a rectangular shape where the X direction is the long side and the Z direction is the short side, as viewed from the Y direction.

The second wiring line 92B includes wiring line side faces 92BA and 92BB constituting both edge faces in the X direction, and wiring line side faces 92BC and 92BD constituting both edge faces in the Y direction. The wiring line side faces 92BA and 92BB are configured along the YZ plane, for example. The wiring line side faces 92BC and 92BD are configured along the XZ plane, for example. The wiring line side faces 92BA and 92BB have a rectangular shape where the Y direction is the long side and the Z direction is the short side, as viewed from the X direction. The wiring line side faces 92BC and 92BD have a rectangular shape where the X direction is the long side and the Z direction is the short side, as viewed from the Y direction.

The first via 83 electrically connects first wiring lines 82A and 82B that are adjacent to each other in the Z direction. In other words, the first wiring lines 82A and 82B that are adjacent to each other in the Z direction are electrically connected by the first via 83. The first via 83 is provided in the insulating film 305.

The first via 83 may be a quadrilateral prism. Thus, the first via 83 includes via side faces 83A and 83B constituting both edge faces in the X direction, and via side faces 83C and 83D constituting both edge faces in the Y direction. The via side faces 83A and 83B are configured along the YZ plane, for example. The via side faces 83C and 83D are configured along the XZ plane, for example. In Embodiment 2, the first via 83 is provided such that the length thereof (Y direction dimension) is greater than the thickness thereof (Z direction dimension). Thus, the via side faces 83A and 83B have a rectangular shape where the Y direction is the long side and the Z direction is the short side, as viewed from the X direction. In Embodiment 2, the Y direction dimension of the via side faces 83A and 83B is approximately double the Z direction dimension of the via side faces 83A and 83B. Also, in Embodiment 2, the first via 83 is provided such that the width thereof (X direction dimension) is greater than the thickness thereof (Z direction dimension). Thus, the via side faces 83C and 83D have a rectangular shape where the X direction is the long side and the Z direction is the short side, as viewed from the Y direction. In Embodiment 2, the X direction dimension of the via side faces 83C and 83D is less than 1.5 times the Z direction dimension of the via side faces 83C and 83D.

The first electrode via 84 connects, to the first electrode plate 40, the first wiring line 82A, among the plurality of first wiring lines 82A and 82B, closest to the first electrode plate 40. The first wiring line 82A and the first electrode plate 40 are electrically connected by the first electrode via 84. In one example, the first electrode via 84 may be disposed at a position overlapping the first via 83 in a plan view.

The first wiring lines 82A and 82B, the first via 83, and the first electrode via 84 may be made of a single metal layer or have a laminate structure with a plurality of different metal layers. The materials forming the first wiring lines 82A and 82B, the first via 83, and the first electrode via 84 may be the same as those of the first wiring lines 62A and 62B, the first vias 63, and the first electrode vias 64 of Embodiment 1 (see FIG. 5).

Each second electrode part 90 is constituted of a plurality of second conductive layers 91 that are stacked from the second electrode plate 50 towards the first electrode plate 40. The second conductive layer 91 closest to the first electrode plate 50, among the plurality of second conductive layers 91, contacts the first electrode plate 50 in the Z direction. On the other hand, the second conductive layer 91 closest to the first electrode plate 40, among the plurality of second conductive layers 91, is separated from the first electrode plate 40 in the Z direction. The insulating layer 30 is interposed between the second conductive layer 91 and the first electrode plate 40 in the Z direction.

The second conductive layer 91 may include a plurality of second wiring lines 92, one second via 93, and one second electrode via 94. The plurality of second wiring lines 92 are arrayed in the Z direction. The plurality of second wiring lines 92 are arrayed so as to be separated from each other in the Z direction. Each second wiring line 92 is a rectangular cuboid with the Y direction dimension being longer than the X direction dimension in a plan view. One of the plurality of second wiring lines 92 is provided in the insulating film 304. Another of the plurality of second wiring lines 92 is provided in the insulating film 306. Below, the second wiring line 92 provided in the insulating film 304 is referred to as the “second wiring line 92A,” and the second wiring line 92 provided in the insulating film 306 is referred to as the “second wiring line 92B.”

The second wiring line 92A is provided in the same position as the first wiring line 82A in the Z direction. The second wiring line 92B is provided in the same position as the first wiring line 82B in the Z direction. The second wiring lines 92A and 92B are disposed at overlapping positions in a plan view. The second wiring line 92A opposes the first wiring line 82B in the X direction. The second wiring line 92A opposes another first wiring line 82B in the Y direction. The second wiring line 92B opposes the first wiring line 82A in the X direction. The second wiring line 92B opposes another first wiring line 82A in the Y direction.

A width W2C of the second wiring line 92A may be equal to a width W2D of the second wiring line 92B. The widths W2C and W2D of the second wiring lines 92A and 92B may be equal to the widths W1C and W1D of the first wiring lines 82A and 82B. A length L2C of the second wiring line 92A may be equal to a length L2D of the second wiring line 92B. The lengths L2C and L2D of the second wiring lines 92A and 92B may be equal to the lengths L1C and L1D of the first wiring lines 82A and 82B.

The second wiring line 92A includes wiring line side faces 92AA and 92AB constituting both edge faces in the X direction, and wiring line side faces 92AC and 92AD constituting both edge faces in the Y direction. The wiring line side faces 92AA and 92AB are configured along the YZ plane, for example. The wiring line side faces 92AA and 92AB have a rectangular shape where the Y direction is the long side and the Z direction is the short side, as viewed from the X direction. The wiring line side faces 92AC and 92AD are configured along the XZ plane, for example. The wiring line side faces 92AC and 92AD have a rectangular shape where the X direction is the long side and the Z direction is the short side, as viewed from the Y direction.

The second wiring line 92B includes wiring line side faces 92BA and 92BB constituting both edge faces in the X direction, and wiring line side faces 92BC and 92BD constituting both edge faces in the Y direction. The wiring line side faces 92BA and 92BB are configured along the YZ plane, for example. The wiring line side faces 92BA and 92BB have a rectangular shape where the Y direction is the long side and the Z direction is the short side, as viewed from the X direction. The wiring line side faces 92BC and 92BD are configured along the XZ plane, for example. The wiring line side faces 92BC and 92BD have a rectangular shape where the X direction is the long side and the Z direction is the short side, as viewed from the Y direction.

If the lengths L2C and L2D of the second wiring lines 92A and 92B are equal to the lengths L1C and L1D of the first wiring lines 82A and 82B, then the areas of the wiring line side faces 92AA and 92AB are equal to the areas of the wiring line side faces 82BA and 82BB of the first wiring line 82B, and the areas of the wiring line side faces 92BA and 92BB are equal to the areas of the wiring line side faces 82AA and 82AB of the first wiring line 82A.

If the widths W2C and W2D of the second wiring lines 92A and 92B are equal to the widths W1C and W1D of the first wiring lines 82A and 82B, then the areas of the wiring line side faces 92AC and 92AD are equal to the areas of the wiring line side faces 82BC and 82BD of the first wiring line 82B, and the areas of the wiring line side faces 92BC and 92BD are equal to the areas of the wiring line side faces 82AC and 82AD of the first wiring line 82A.

The second wiring line 92A opposes the first wiring line 82B in the X direction. More specifically, the wiring line side face 92AA of the second wiring line 92A opposes the wiring line side face 82BB of the first wiring line 82B in the X direction. The wiring line side faces 92AA and 82BB are both along the YZ plane, and thus, the distance between the wiring line side face 92AA and the wiring line side face 82BB in the X direction is constant throughout the entire length of the wiring line side faces 92AA and 82BB in the Y direction, and is constant throughout the entire width of the wiring line side faces 92AA and 82BB in the Z direction. Also, the wiring line side face 92AB of the second wiring line 92A opposes the wiring line side face 82BA of another first wiring line 82B in the X direction. More specifically, the wiring line side face 92AB of the second wiring line 92A opposes the wiring line side face 82BA of the other first wiring line 82B in the X direction. The wiring line side faces 92AB and 82BA are both along the YZ plane, and thus, the distance between the wiring line side face 92AB and the wiring line side face 82BA in the X direction is constant throughout the entire length of the wiring line side faces 92AB and 82BA in the Y direction, and is constant throughout the entire width of the wiring line side faces 92AB and 82BA in the Z direction.

The second wiring line 92A opposes the first wiring line 82B in the Y direction. More specifically, the wiring line side face 92AC of the second wiring line 92A opposes the wiring line side face 82BD of the first wiring line 82B in the X direction. The wiring line side faces 92AC and 82BD are both along the XZ plane, and thus, the distance between the wiring line side face 92AC and the wiring line side face 82BD in the Y direction is constant throughout the entire length of the wiring line side faces 92AC and 82BD in the X direction, and is constant throughout the entire width of the wiring line side faces 92AC and 82BD in the Z direction. Also, the wiring line side face 92AD of the second wiring line 92A opposes the wiring line side face 82BC of another first wiring line 82B in the X direction. The wiring line side faces 92AD and 82BC are both along the XZ plane, and thus, the distance between the wiring line side face 92AD and the wiring line side face 82BC in the Y direction is constant throughout the entire length of the wiring line side faces 92AD and 82BC in the X direction, and is constant throughout the entire width of the wiring line side faces 92AD and 82BC in the Z direction.

The second wiring line 92B opposes the first wiring line 82A in the X direction. More specifically, the wiring line side face 92BA of the second wiring line 92B opposes the wiring line side face 82AB of the first wiring line 82A in the X direction. The wiring line side faces 92BA and 82AB are both along the YZ plane, and thus, the distance between the wiring line side face 92BA and the wiring line side face 82AB in the X direction is constant throughout the entire length of the wiring line side faces 92BA and 82AB in the Y direction, and is constant throughout the entire width of the wiring line side faces 92BA and 82AB in the Z direction. Also, the wiring line side face 92BB of the second wiring line 92B opposes the wiring line side face 82AA of another first wiring line 82A in the X direction. More specifically, the wiring line side face 92BB of the second wiring line 92B opposes the wiring line side face 82AA of the other first wiring line 82A in the X direction. The wiring line side faces 92BB and 82AA are both along the YZ plane, and thus, the distance between the wiring line side face 92BB and the wiring line side face 82AA in the X direction is constant throughout the entire length of the wiring line side faces 92BB and 82AA in the Y direction, and is constant throughout the entire width of the wiring line side faces 92BB and 82AA in the Z direction.

The second wiring line 92B opposes the first wiring line 82A in the Y direction. More specifically, the wiring line side face 92BC of the second wiring line 92B opposes the wiring line side face 82AD of the first wiring line 82A in the X direction. The wiring line side faces 92BC and 82AD are both along the XZ plane, and thus, the distance between the wiring line side face 92BC and the wiring line side face 82AD in the Y direction is constant throughout the entire length of the wiring line side faces 92BC and 82AD in the X direction, and is constant throughout the entire width of the wiring line side faces 92BC and 82AD in the Z direction. Also, the wiring line side face 92BD of the second wiring line 92B opposes the wiring line side face 82AC of another first wiring line 82A in the X direction. The wiring line side faces 92BD and 82AC are both along the XZ plane, and thus, the distance between the wiring line side face 92BD and the wiring line side face 82AC in the Y direction is constant throughout the entire length of the wiring line side faces 92BD and 82AC in the X direction, and is constant throughout the entire width of the wiring line side faces 92BD and 82AC in the Z direction.

The second wiring line 92B opposes the first electrode plate 40 in the Z direction. More specifically, the second wiring line 92B is disposed across the insulating film 303 from the first electrode plate 40. Thus, a distance DL in the Z direction between the second wiring line 92A and the second wiring line 92B may be equal to a distance DM in the Z direction between the second wiring line 92B and the first electrode plate 40. The distance DL may be equal to the distance DK in the Z direction between the first wiring line 82B and the second electrode plate 50.

The second via 93 electrically connects second wiring lines 92A and 92B that are adjacent to each other in the Z direction. In other words, the second wiring lines 92A and 92B that are adjacent to each other in the Z direction are electrically connected by the second via 93. The second via 93 is provided in the insulating film 305. In other words, the second via 93 is disposed in the same position as the first via 83 in the Z direction. The second via 93 may oppose the first via 83 in the X direction. The second via 93 may oppose another first via 83 in the Y direction. In one example, the size of the second via 93 may be equal to the size of the first via 83.

The second via 93 may be a quadrilateral prism. Thus, the second via 93 includes via side faces 93A and 93B constituting both edge faces in the X direction, and via side faces 93C and 93D constituting both edge faces in the Y direction. The via side faces 93A and 93B are configured along the YZ plane, for example. In Embodiment 2, the second via 93 is provided such that the length thereof (Y direction dimension) is greater than the thickness thereof (Z direction dimension). Thus, the via side faces 93A and 93B have a rectangular shape where the Y direction is the long side and the Z direction is the short side, as viewed from the X direction. In Embodiment 2, the Y direction dimension of the via side faces 93A and 93B is less than 1.5 times the Z direction dimension of the via side faces 93A and 93B. The via side faces 93C and 93D are configured along the XZ plane, for example. In Embodiment 2, the second via 93 is provided such that the width thereof (X direction dimension) is greater than the thickness thereof (Z direction dimension). Thus, the via side faces 93C and 93D have a rectangular shape where the X direction is the long side and the Z direction is the short side, as viewed from the Y direction. In Embodiment 2, the X direction dimension of the via side faces 93C and 93D is less than 1.5 times the Z direction dimension of the via side faces 93C and 93D.

The second via 93 may oppose the first via 83 in the X direction. More specifically, the via side face 93A of the second via 93 may oppose the via side face 83B of the first via 83 in the X direction. The via side faces 93A and 93B are both along the YZ plane, and thus, the distance between the via side face 93A and the via side face 83B in the X direction is constant throughout the entire length of the via side faces 93A and 83B in the Y direction, and is constant throughout the entire width of the via side faces 93A and 83B in the Z direction. Also, the via side face 93B of the second via 93 opposes the via side face 83A of another first via 83 in the X direction. More specifically, the via side face 93B of the second via 93 opposes the via side face 83A of the other first via 83 in the X direction. The via side faces 93B and 83A are both along the YZ plane, and thus, the distance between the via side face 93B and the via side face 83A in the X direction is constant throughout the entire length of the via side faces 93B and 83A in the Y direction, and is constant throughout the entire width of the via side faces 93B and 83A in the Z direction.

The second via 93 may oppose the first via 83 in the Y direction. More specifically, the via side face 93C of the second via 93 may oppose the via side face 83D of the first via 83 in the Y direction. The via side faces 93C and 83D are both along the XZ plane, and thus, the distance between the via side face 93C and the via side face 83D in the Y direction is constant throughout the entire length of the via side faces 93C and 83D in the X direction, and is constant throughout the entire width of the via side faces 93C and 83D in the Z direction. Also, the via side face 93D of the second via 93 opposes the via side face 83C of another first via 83 in the Y direction. The via side faces 93D and 83C are both along the XZ plane, and thus, the distance between the via side face 93D and the via side face 83C in the Y direction is constant throughout the entire length of the via side faces 93D and 83C in the X direction, and is constant throughout the entire width of the via side faces 93D and 83C in the Z direction.

The second electrode via 94 connects, to the second electrode plate 50, the second wiring line 92A, among the plurality of second wiring lines 92A and 92B, closest to the second electrode plate 50. The second wiring line 92A and the second electrode plate 50 are electrically connected by the second electrode via 94. In one example, the second electrode via 94 may be disposed at a position overlapping the second via 93 in a plan view. In Embodiment 2, the second electrode via 94 is provided in the insulating film 307. Thus, the second electrode via 94 is provided further towards the first surface 31 of the insulating layer 30 than the first electrode parts 80.

The second wiring lines 92A and 92B, the second vias 93, and the second electrode vias 94 may be made of a single metal layer or have a laminate structure with a plurality of different metal layers. The materials forming the first wiring lines 92A and 92B, the second via 93, and the second electrode via 94 may be the same as those of the second wiring lines 72A and 72B, the second vias 73, and the second electrode vias 74 of Embodiment 1 (see FIG. 5).

The capacitor 10 is constituted of the first electrode parts 80, the second electrode parts 90, and the insulating layer 30 between the first electrode parts 80 and the second electrode parts 90 in the X direction. More specifically, a portion of the capacitor is constituted of the first wiring line 82A, the second wiring line 92B opposing the first wiring line 82A in the X direction, and the insulating layer 30 between the first wiring line 82A and the second wiring line 92B in the X direction. A portion of the capacitor is constituted of the first wiring line 82A, the second wiring line 92B opposing the first wiring line 82A in the Y direction, and the insulating layer 30 between the first wiring line 82A and the second wiring line 92B in the Y direction. A portion of the capacitor is constituted of the first wiring line 82B, the second wiring line 92A opposing the first wiring line 82B in the X direction, and the insulating layer 30 between the first wiring line 82B and the second wiring line 92A in the X direction. A portion of the capacitor is constituted of the first wiring line 82B, the second wiring line 92A opposing the first wiring line 82B in the Y direction, and the insulating layer 30 between the first wiring line 82B and the second wiring line 92A in the Y direction. A portion of the capacitor is constituted of the first via 83, the second via 93 opposing the first via 83 in the X direction, and the insulating layer 30 between the first via 83 and the second via 93 in the X direction. A portion of the capacitor is constituted of the first via 83, the second via 93 opposing the first via 83 in the Y direction, and the insulating layer 30 between the first via 83 and the second via 93 in the Y direction. A portion of the capacitor is constituted of the first wiring line 82B, the second electrode plate 50, and the insulating layer 30 between the first wiring line 82B and the second electrode plate 50 in the Z direction. A portion of the capacitor is constituted of the second wiring line 92B, the first electrode plate 40, and the insulating layer 30 between the second wiring line 92B and the first electrode plate 40 in the X direction.

### Effects of Embodiment 2

The following effects can be attained by the capacitor 10 of Embodiment 2.
(2-1) The plurality of first electrode parts 80 and the plurality of second electrode parts 90 are arrayed alternately in the Y direction in a plan view, and oppose each other in the y direction. The plurality of first electrode parts 80 and the plurality of second electrode parts 90 are arrayed alternately in the X direction in a plan view, and oppose each other in the X direction.

According to this configuration, compared to a configuration in which the first electrode parts 80 and the second electrode part 90 oppose each other in both the X direction and the Y direction, the opposing area of the first electrode parts 80 and the second electrode parts 90 can be increased. Thus, the capacitance of the capacitor 10 can be increased. Also, assuming that the capacitances of the capacitors are equal, it is possible to reduce the size of the capacitor 10 compared to a case in which the first electrode parts 80 and the second electrode parts 90 oppose each other in only one of the X direction or the Y direction.
(2-2) The plurality of first electrode parts 80 and the plurality of second electrode parts 90 are arrayed so as to alternate one each in the X direction and so as to alternate one each in the Y direction.

According to this configuration, each first electrode part 80 has second electrode parts 90 disposed on both sides thereof in the X direction and both sides thereof in the Y direction. Additionally, each second electrode part 90 has first electrode parts 80 disposed on both sides thereof in the X direction and both sides thereof in the Y direction. As a result, the ratio of the area of one first electrode part 80 opposing the second electrode part 90 to the area not opposing the second electrode part 90 is increased. Also, the ratio of the area of one second electrode part 90 opposing the first electrode part 80 to the area not opposing the first electrode part 80 is increased. Thus, a capacitor can be formed efficiently between the first electrode parts 80 and the second electrode parts 90.
(2-3) An arrangement pitch PX1 for the plurality of first electrode parts 80 in the X direction is equal to an arrangement pitch PY1 for the plurality of first electrode parts 80 in the Y direction. An arrangement pitch PX2 for the plurality of second electrode parts 90 in the X direction is equal to an arrangement pitch PY2 for the plurality of second electrode parts 90 in the Y direction.

According to this configuration, the plurality of first electrode parts 80 and the plurality of second electrode parts 90 can be arranged in a matrix so as to oppose each other in the X direction and the Y direction. As a result, then it is possible to dispose the first electrode parts 80 and the second electrode parts 90 at a high density.
(2-4) The plurality of first conductive layers 81 of the first electrode parts 80 include the plurality of first wiring lines 82A and 82B arrayed in the Z direction, first vias 83 that electrically connect first wiring lines 82A and 82B that are adjacent to each other in the Z direction, and first electrode vias 84 that connect the first electrode plate 40 to the first wiring line 82A closest to the first electrode plate 40 among the plurality of first wiring lines 82A and 82B. The plurality of second conductive layers 91 of the second electrode parts 90 include the plurality of second wiring lines 92A and 92B arrayed in the Z direction, second vias 93 that electrically connect second wiring lines 92A and 92B that are adjacent to each other in the Z direction, and second electrode vias 94 that connect the second electrode plate 50 to the second wiring line 92A closest to the second electrode plate 50 among the plurality of second wiring lines 92A and 92B. The plurality of first wiring lines 82A and 82B and the plurality of second wiring lines 92A and 92B oppose each other in both the X direction and Y direction.

According to this configuration, a capacitor is formed as a result of the first wiring lines 82A and 82B opposing the second wiring lines 92A and 92B in the X direction, and a portion of a capacitor is formed as a result of the first wiring lines 82A and 82B opposing the second wiring lines 92A and 92B in the Y direction. Thus, the opposing area of the first wiring lines 82A and 82B and the second wiring lines 92A and 92B is greater than a case in which the first wiring lines 82A and 82B and the second wiring lines 92A and 92B oppose each other in only the X direction or only the Y direction. Thus, the capacitance of the capacitor 10 can be increased. Furthermore, assuming the capacitances of the capacitors are equal, the plurality of first electrode parts 80 and the plurality of second electrode parts 90 can be reduced in number compared to a case in which the first wiring lines 82A and 82B and the second wiring lines 92A and 92B oppose each other in only the X direction or only the Y direction. Thus, the size of the capacitor 10 can be reduced.
(2-5) The plurality of first vias 83 and the plurality of second vias 93 oppose each other in both the X direction and Y direction.

According to this configuration, a capacitor is formed as a result of the first vias 83 opposing the second vias 93 in the X direction, and a capacitor is formed as a result of the first vias 83 opposing the second vias 93 in the Y direction. Thus, the corresponding area of the first vias 83 and the second vias 93 is greater than a case in which the first vias 83 and the second vias 93 oppose each other in only the X direction or only the Y direction. Thus, the capacitance of the capacitor 10 can be increased. Furthermore, assuming the capacitances of the capacitors are equal, the plurality of first electrode parts 80 and the plurality of second electrode parts 90 can be reduced in number compared to a case in which the first vias 83 and the second vias 93 oppose each other in only the X direction or only the Y direction. Thus, the size of the capacitor 10 can be reduced.

### Application Example of Capacitor

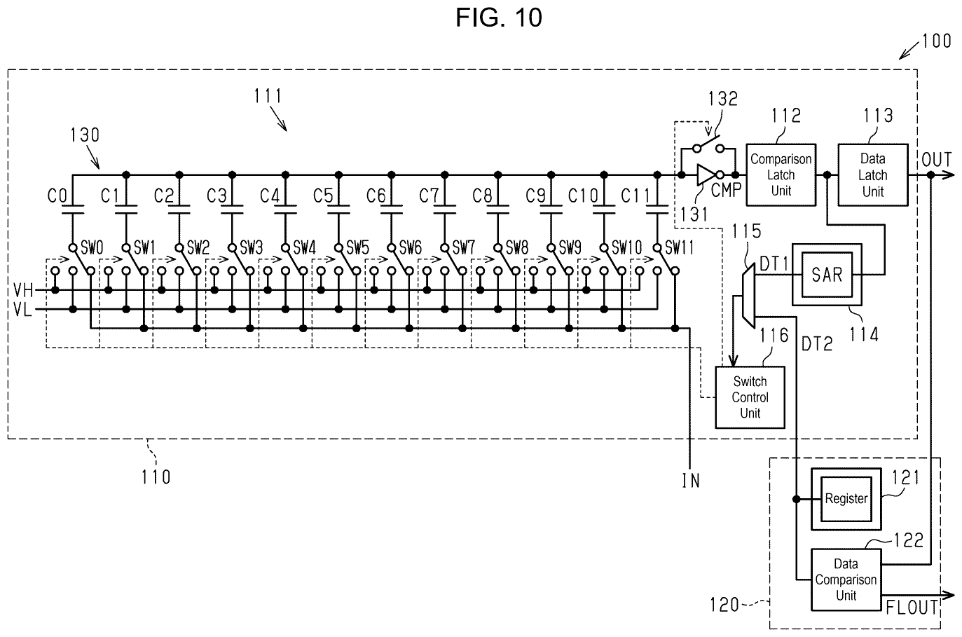

Application examples of a capacitor 10 according to each embodiment will be described below with reference to FIGS. 10. FIG. 10 schematically shows a circuit configuration of an analog-digital converter (ADC) 100 including the capacitor 10.

As shown in FIG. 10, the ADC 100 includes an analog-digital (AD) conversion unit 110 and an anomaly detection unit 120.

The AD conversion unit 110 is configured so as to convert an input signal IN, which is an analog signal, to an output signal OUT, which is a digital signal, and then output the output signal OUT to outside of the ADC 100. The AD conversion unit 110 is configured so as to perform successive approximation AD conversion.

The AD conversion unit 110 includes a comparator 111, a comparison latch unit 112, a data latch unit 113, a first digital analog converter (DAC) data generation unit 114, a selector 115, and a switch control unit 116.

The comparator 111 is configured to output a comparison signal CMP on the basis of a comparison between the input signal IN and analog data ADAT outputted from a DAC (not shown). More specifically, the comparator 111 is configured to perform a sampling operation of the input signal IN and a comparison operation for comparing the input signal IN to the analog data ADAT.

The comparator 111 includes a capacitive DAC 130, an inverter 131, and a switch 132. The capacitive DAC 130 includes capacitors C0 to C11 and switches SW0 to SW11. The number of capacitors C0 to C11 and the number of switches SW0 to SW11 can be freely modified.

First terminals of each of the capacitors C0 to C11 are all connected to the same input terminal of the inverter 131. The switches SW0 to SW11 are each configured to selectively switch the connection between the second terminals of the capacitors C0 to C11 and any of the application terminal for the input signal IN, the application terminal for a high voltage VH, and an application terminal for a low voltage VL. The switch 132 is configured so as to switch between conduction and interruption between the input and output terminals of the inverter 131.

The comparison latch unit 112 is configured so as to retain the comparison signal CMP outputted from the comparator 111. That is, the comparison latch unit 112 is configured to retain a high or low 1-bit signal.

The data latch unit 113 is configured so as to retain high or low data for each bit corresponding to the retained data of the comparison latch unit 112. The data latch unit 113 is configured to retain 12-bit data, for example. The 12-bit data retained in the data latch unit 113 is outputted as the output signal OUT.

The first DAC data generation unit 114 includes a successive approximation register (SAR). The first DAC data generation unit 114 is configured so as to generate first DAC data DT1, which is digital data, corresponding to the retained data of the comparison latch unit 112.

The selector 115 is configured such that during normal operation of converting the input signal IN to the output signal OUT, the selector 115 selects the first DAC data DT1, among the first DAC data DT1 and second DAC data DT2 to be described later, and then outputs the first DAC data DT1 to the switch control unit 116.

The switch control unit 116 is configured so as to control the switches SW0 to SW11 and the switch 132 on the basis of the first DAC data DT1.

The anomaly detection unit 120 is provided in order to confirm that the AD conversion unit 110 is in normal operation. The anomaly detection unit 120 includes a second DAC data generation unit 121 and a data comparison unit 122.

The second DAC data generation unit 121 includes a register. The second DAC data generation unit 121 is configured such that during a test operation for confirming whether the AD conversion unit 110 is in normal operation, the second DAC data generation unit 121 generates second DAC data DT2, which is prescribed 12-bit data, and then outputs the same to the selector 115. The selector 115 is configured such that during the test operation, the selector 115 selects the second DAC data DT2, among the first DAC data DT1 and the second DAC data DT2, and then outputs the second DAC data DT2 to DAC.

The data comparison unit 122 is configured so as to perform comparison between the second DAC data DT2 outputted from the second DAC data generation unit 121 and the output signal OUT and output a detection signal FLOUT to outside of the ADC 100 as a comparison result. The detection signal FLOUT is an anomaly detection signal that indicates whether the AD conversion unit 110 is in normal operation.

In such an ADC 100, the capacitor 10 of each embodiment may be used as the capacitors C0 to C11 in the capacitive DAC of the comparator 111. If the ADC 100 is provided as a semiconductor chip, then the capacitor 10 may be provided as a partial region of the semiconductor chip. The capacitor 10 of each embodiment can achieve a greater capacitance therein as a result of the opposing arrangement of the first electrode plate 40, the plurality of first electrode parts 60 (80), the second electrode plate 50, and the plurality of second electrode parts 70 (90). Thus, as long as the capacitance of the capacitor 10 is the same, the size of the capacitor 10 can be reduced. Thus, if the ADC 100 is provided as a semiconductor chip, it is possible to reduce the area occupied by the capacitor 10. Thus, the size of the semiconductor chip can be reduced.

### Modification Examples

The embodiments above can be modified as described below. Also, the embodiments and the modification examples described below can be implemented in combination with each other as long as such a combination is technically compatible.

In Embodiment 1, the configuration of the plurality of first conductive layers 61 of the first electrode part 60 and the configuration of the plurality of second conductive layers 71 of the second electrode part 70 can be freely modified. In one example, the number of first wiring lines in the plurality of first conductive layers 61 can be freely modified. In one example, three or more first wiring lines may be provided so as to be separated from each other in the Z direction. The number of first vias 63 may be set according to the number of first wiring lines, for example. In another example, one first wiring line may be provided. If only one first wiring line is provided, the first via 63 may be omitted.

In one example, the number of second wiring lines in the plurality of second conductive layers 71 can be freely modified. In one example, three or more second wiring lines may be provided so as to be separated from each other in the Z direction. The number of second vias 73 may be set according to the number of second wiring lines, for example. In another example, one second wiring line may be provided. If only one second wiring line is provided, the second via 73 may be omitted.

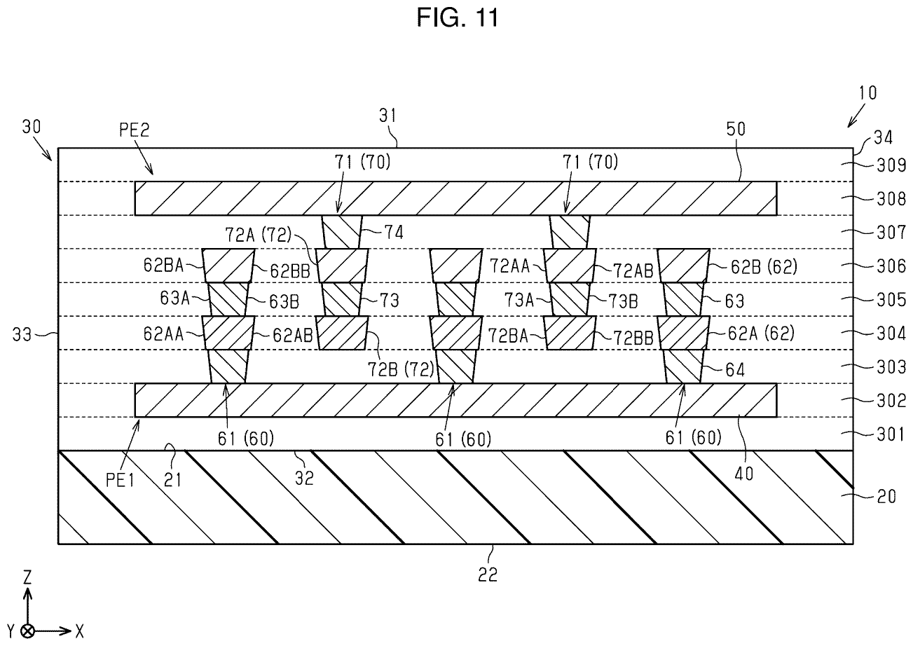

In Embodiment 1, the shape of the first wiring lines 62A and 62B as seen from the Y direction can be freely modified. In one example, as shown in FIG. 11, each of the first wiring lines 62A and 62B may have a tapered shape by which the width (X direction dimension) thereof decreases from the first surface 31 to the second surface 32 of the insulating layer 30. A similar modification may be made for the first wiring lines 82A and 82B of Embodiment 2. The first wiring lines 82A and 82B may be truncated quadrilateral pyramids.

In Embodiment 1, the shape of the second wiring lines 72A and 72B as seen from the Y direction can be freely modified. In one example, as shown in FIG. 11, each of the second wiring lines 72A and 72B may have a tapered shape by which the width (X direction dimension) thereof decreases from the first surface 31 to the second surface 32 of the insulating layer 30. A similar modification may be made for the second wiring lines 92A and 92B of Embodiment 2. The second wiring lines 92A and 92B may be truncated quadrilateral pyramids.

In Embodiment 1, the shape of the first vias 63 as seen from the Y direction can be freely modified. In one example, as shown in FIG. 11, the first vias 63 may have a tapered shape by which the width (X direction dimension) thereof decreases from the first surface 31 to the second surface 32 of the insulating layer 30. A similar modification may be made for the first vias 83 of Embodiment 2. The first vias 83 may be truncated quadrilateral pyramids. In another example, the first vias 63 and 83 may be cylinders or truncated cones.

In Embodiment 1, corner sections constituting the four corners of the first vias 63, which are quadrilateral in a plan view, may have a curved shape so as to protrude outward. A similar modification may be made for the first vias 83 of Embodiment 2.

In Embodiment 1, the shape of the second vias 73 as seen from the Y direction can be freely modified. In one example, as shown in FIG. 11, the second vias 73 may have a tapered shape by which the width (X direction dimension) thereof decreases from the first surface 31 to the second surface 32 of the insulating layer 30. A similar modification may be made for the second vias 93 of Embodiment 2. The second vias 93 may be truncated quadrilateral pyramids. In another example, the second vias 73 and 93 may be cylinders or truncated cones.

In Embodiment 1, corner sections constituting the four corners of the second vias 73, which are quadrilateral in a plan view, may have a curved shape so as to protrude outward. A similar modification may be made for the second vias 93 of Embodiment 2.

In Embodiment 1, the shape of the first electrode vias 64 as seen from the Y direction can be freely modified. In one example, as shown in FIG. 11, the first electrode vias 64 may have a tapered shape by which the width (X direction dimension) thereof decreases from the first surface 31 to the second surface 32 of the insulating layer 30. A similar modification may be made for the first electrode vias 84 of Embodiment 2. The first electrode vias 84 may be truncated quadrilateral pyramids. In another example, the first electrode vias 64 and 84 may be cylinders or truncated cones.

In Embodiment 1, the shape of the second electrode vias 74 as seen from the Y direction can be freely modified. In one example, as shown in FIG. 11, the second electrode vias 74 may have a tapered shape by which the width (X direction dimension) thereof decreases from the first surface 31 to the second surface 32 of the insulating layer 30. A similar modification may be made for the second electrode vias 94 of Embodiment 2. The second electrode vias 94 may be truncated quadrilateral pyramids. In another example, the second electrode vias 74 and 94 may be cylinders or truncated cones.

In Embodiment 1, the Y direction lengths of the first vias 63 and the first electrode vias 64 can be freely modified.

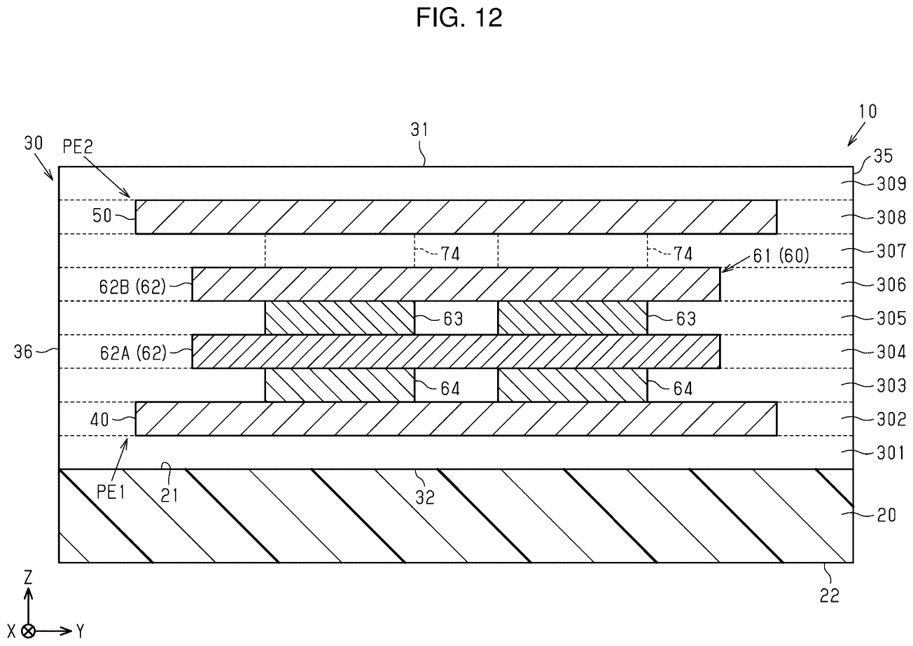

In one example, as shown in FIG. 12, the Y direction length of the first vias 63 may be more than 1.5 times the thickness (Z direction dimension) of the first vias 63. In one example, the Y direction length of the first vias 63 may be more than double the thickness of the first vias 63. In one example, the Y direction length of the first vias 63 may be more than triple the thickness of the first vias 63. In one example, the Y direction length of the first vias 63 may be more than double the width (X direction dimension) of the first vias 63.

In one example, as shown in FIG. 12, the Y direction length of the first electrode vias 64 may be more than 1.5 times the thickness (Z direction dimension) of the first electrode vias 64. In one example, the Y direction length of the first electrode vias 64 may be more than double the thickness of the first electrode vias 64. In one example, the Y direction length of the first electrode vias 64 may be more than triple the thickness of the first electrode vias 64. In one example, the Y direction length of the first electrode vias 64 may be more than double the width (X direction dimension) of the first electrode vias 64.

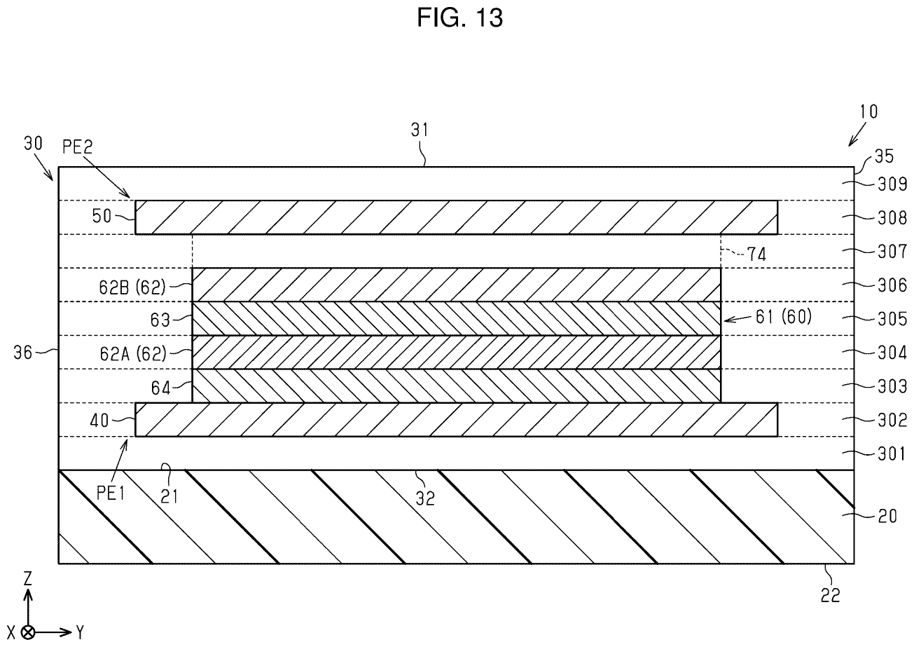

In one example, as shown in FIG. 13, the Y direction length of the first vias 63 may be equal to the Y direction length of the first wiring lines 62A and 62B. In another example, the Y direction length of the first electrode vias 64 may be equal to the Y direction length of the first wiring lines 62A and 62B.

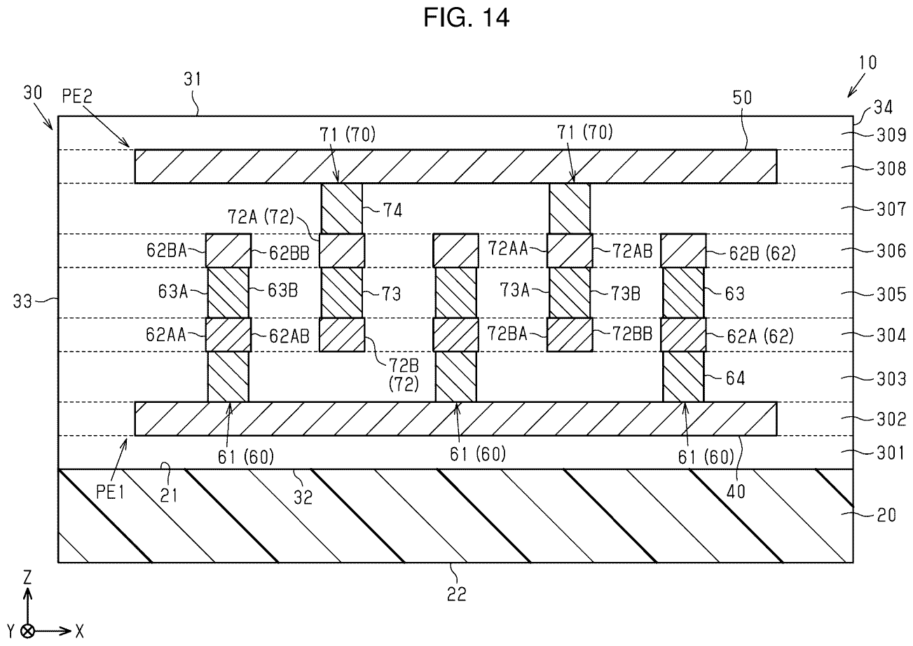

In Embodiment 1, the thicknesses (Z direction dimensions) of the first vias 63 and the first electrode vias 64 can be freely modified. In one example, as shown in FIG. 14, the thickness of the first vias 63 may be greater than the thickness (Z direction dimension) of the first wiring lines 62A and 62B. The thickness of the first electrode vias 64 may be greater than the thickness of the first wiring lines 62A and 62B. The thicknesses of the first vias 83 and the first electrode vias 84 of Embodiment 2 may be similarly modified.

In Embodiment 1, the thicknesses (Z direction dimensions) of the second vias 73 and the second electrode vias 74 can be freely modified. In one example, as shown in FIG. 14, the thickness of the second vias 73 may be greater than the thickness (Z direction dimension) of the second wiring lines 72A and 72B. The thickness of the second electrode vias 74 may be greater than the thickness of the second wiring lines 72A and 72B. The thicknesses of the second vias 93 and the second electrode vias 94 of Embodiment 2 may be similarly modified.

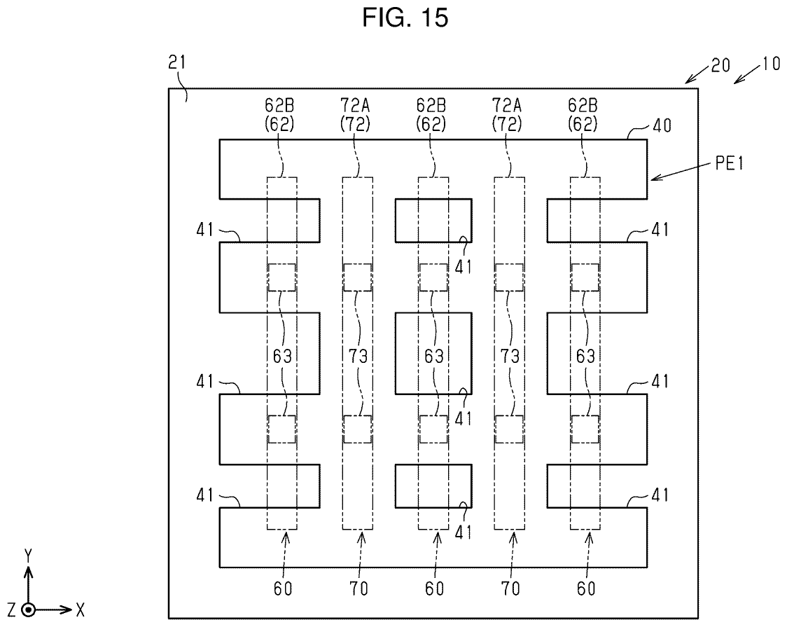

In Embodiment 1, the configuration of the first electrode plate 40 can be freely modified. In one example, as shown in FIG. 15, the first electrode plate 40 may include slits 41. The slits 41 are provided at positions differing from the plurality of first electrode parts 60 in a plan view. A plurality of the slits 41 may be provided so as to be separated from each other in the X and Y directions. The insulating layer 30 is provided in the slits 41. In the example shown in FIG. 15, the slits 41 extend in the X direction. In other words, the slits 41 extend in a direction perpendicular to the direction that the first wiring lines 62A and 62B extend. The slits 41 may also be provided in the first electrode plate 40 of Embodiment 2.

In Embodiment 1, the Y direction length of the first wiring lines 62A and 62B can be freely modified. In one example, the Y direction length of the first wiring lines 62A may differ from the Y direction length of the first wiring lines 62B. A similar modification may be made for the Y direction lengths of the first wiring lines 82A and 82B of Embodiment 2.

In Embodiment 1, the Y direction length of the second wiring lines 72A and 72B can be freely modified. In one example, the Y direction length of the second wiring lines 72A may differ from the Y direction length of the second wiring lines 72B. A similar modification may be made for the Y direction lengths of the second wiring lines 92A and 92B of Embodiment 2.

In Embodiment 1, the Y direction length of the first wiring lines 62A and 62B may differ from the Y direction length of the second wiring lines 72A and 72B. A similar modification may be made for the first wiring lines 82A and 82B and the second wiring lines 92A and 92B of Embodiment 2.

In Embodiment 1, the positional relationship between the plurality of first vias 63 and the plurality of second vias 73 can be freely modified. In one example, the first vias 63 need not oppose the second vias 73 in the X direction.

In Embodiment 1, the positional relationship between the plurality of first electrode vias 64 and the plurality of second electrode vias 74 can be freely modified. In one example, the first electrode vias 64 may oppose the second electrode vias 74 in the X direction.

In Embodiment 1, each of the second wiring lines 72A and 72B may be disposed at a position offset from the X direction center between two first wiring lines 62A and 62B that are adjacent to each other in the X direction.

In Embodiment 1, the arrangement pitch P1 of the first electrode parts 60 may differ from the arrangement pitch P2 of the second electrode parts 70.

In Embodiment 1, the configuration of the first electrode parts 60 and the second electrode parts 70 can be freely modified.

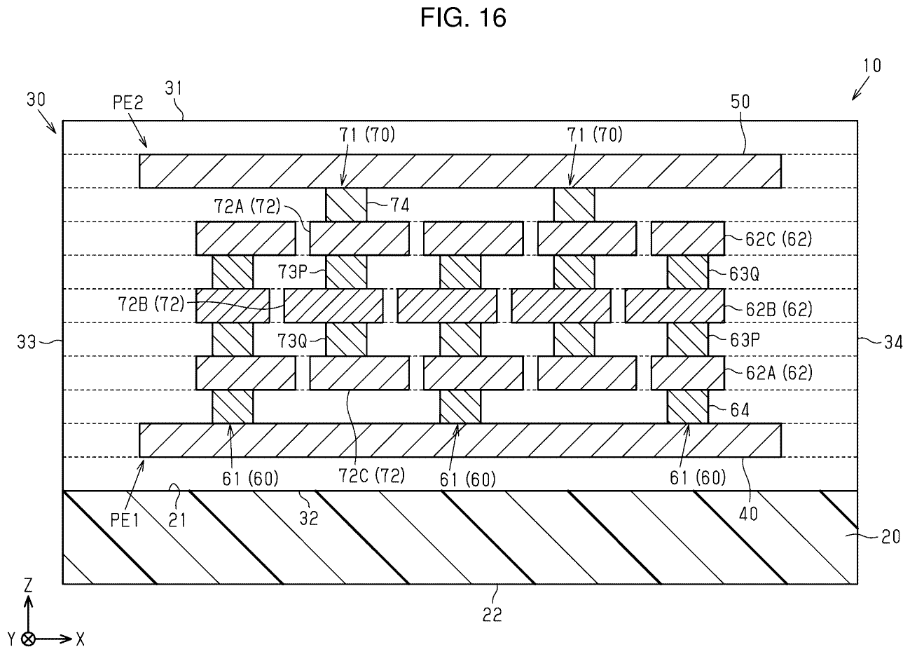

In one example, as shown in FIG. 16, the plurality of first conductive layers 61 of the first electrode parts 60 include a plurality of first wiring lines 62A, 62B, and 62C, a plurality of first vias 63P and 63Q, and the plurality of first electrode vias 64.

The plurality of first wiring lines 62A, 62B, and 63C, are arrayed so as to be separated from each other in the Z direction. The first wiring lines 62A are disposed further towards the first electrode plate 40 than the first wiring lines 62B and 62C. The first wiring lines 62A are connected to the first electrode plate 40 by the plurality of first electrode vias 64. The first wiring line 62B is disposed between the first wiring line 62A and the first wiring line 62C in the Z direction. The first wiring line 62A and the first wiring line 62B are connected by the plurality of first vias 63P. The plurality of first vias 63P are arranged so as to be separated from each other in the Y direction. The first wiring line 62B and the first wiring line 62C are connected by the plurality of first vias 63Q. The plurality of first vias 63Q are arrayed so as to be separated from each other in the Y direction.

The plurality of second conductive layers 71 of the second electrode parts 70 include a plurality of second wiring lines 72A, 72B, and 72C, a plurality of first vias 73P and 73Q, and the plurality of first electrode vias 74.

The plurality of second wiring lines 72A, 72B, and 73C, are arrayed so as to be separated from each other in the Z direction. The second wiring lines 72A are disposed further towards the second electrode plate 50 than the second wiring lines 72B and 72C. The second wiring lines 72A are connected to the second electrode plate 50 by the plurality of second electrode vias 74. The second wiring line 72B is disposed between the second wiring line 72A and the second wiring line 72C in the Z direction. The second wiring line 72A and the second wiring line 72B are connected by the plurality of second vias 73P. The plurality of second vias 73P are arranged so as to be separated from each other in the Y direction. The second wiring line 72B and the second wiring line 72C are connected by the plurality of second vias 73Q. The plurality of second vias 73Q are arrayed so as to be separated from each other in the Y direction.

The first wiring lines 62A and the second wiring lines 72C are disposed at the same position in the Z direction and oppose each other in the X direction. The first wiring lines 62B and the second wiring lines 72B are disposed at the same position in the Z direction and oppose each other in the X direction. The first wiring lines 62C and the second wiring lines 72A are disposed at the same position in the Z direction and oppose each other in the X direction.

In the example shown in FIG. 16, the first wiring line 62B is disposed further to the X direction than the first wiring lines 62A and 62C. The second wiring line 72B is disposed further to the X direction than the second wiring lines 72A and 72C. As a result, the first wiring line 62B includes portions opposing the second wiring lines 72A and 72C in the Z direction. The second wiring line 72B includes portions opposing the first wiring lines 62A and 62C in the Z direction.

Thus, in the capacitor 10 of the modification example, a portion of a capacitor is formed as a result of the portions of the first wiring line 62B and the second wiring line 72A opposing each other in the Z direction, and a portion of a capacitor is formed as a result of the portions of the first wiring line 62B and the second wiring line 72C opposing each other in the Z direction. A portion of a capacitor is formed as a result of portions of the second wiring line 72B and the first wiring line 62A opposing each other in the Z direction, and a portion of a capacitor is formed as a result of portions of the second wiring line 72B and the first wiring line 62C opposing each other in the Z direction. As a result, the capacitance of the capacitor 10 of the modification example can be increased.

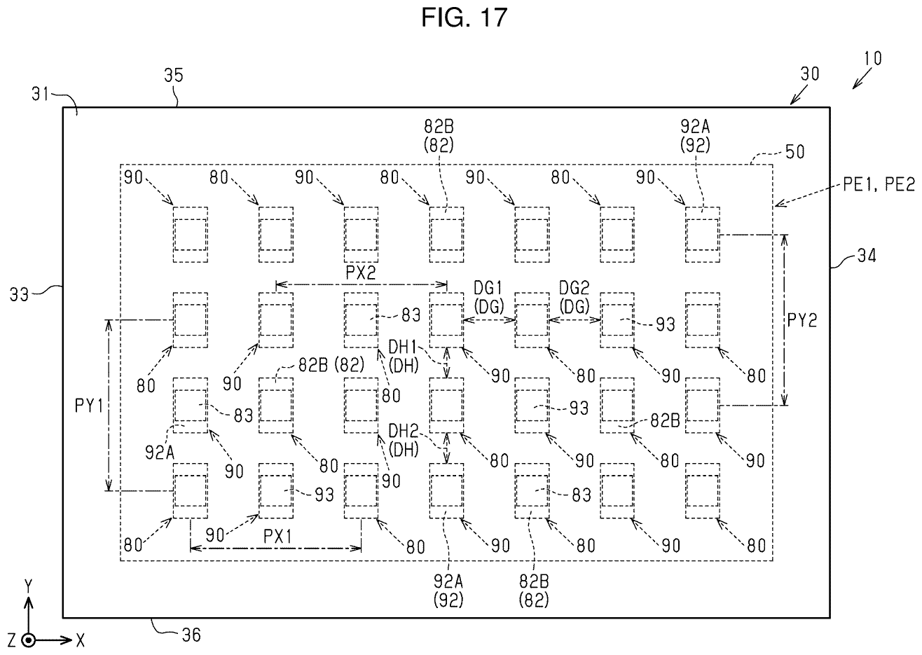

In Embodiment 2, as shown in FIG. 17, the plurality of second electrode parts 90 may be arrayed so as to be separated from each in the Y direction. In the example shown in FIG. 17, an arrangement pitch PX2 for the plurality of second electrode parts 90 in the X direction is equal to an arrangement pitch PY2 for the plurality of second electrode parts 90 in the Y direction. An arrangement pitch PY2 for the plurality of second electrode parts 90 in the Y direction may be equal to an arrangement pitch PY1 for the plurality of first electrode parts 80 in the Y direction.

In the example shown in FIG. 17, a distance DG between the first electrode parts 80 and the second electrode parts 90 in the X direction is greater than a distance DH between the first electrode parts 80 and the second electrode parts 90 in the Y direction. The distance DG may be equal to the distance DH. In this case, the arrangement pitches PY1 and PY2 may be greater than the arrangement pitches PX1 and PX2.

In Embodiment 2, the arrangement pitch PX1 of the plurality of first electrode parts 80 in the X direction may differ from the arrangement pitch PX2 of the plurality of second electrode parts 80 in the Y direction. Also, the arrangement pitch PX2 for the plurality of second electrode parts 90 in the X direction may differ from the arrangement pitch PY2 for the plurality of second electrode parts 90 in the Y direction.

In Embodiment 2, the plurality of first wiring lines 82A and 82B and the plurality of second wiring lines 92A and 92B may oppose each other in only one of the X direction or the Y direction.

In Embodiment 2, the plurality of first vias 83 and the plurality of second vias 93 may oppose each other in only one of the X direction or the Y direction.

In Embodiment 2, the plurality of first electrode vias 84 and the plurality of second electrode vias 94 may oppose each other in only one of the X direction or the Y direction.

In the embodiments, the second electrode plate 50 may be larger than the first electrode plate 40 in a plan view. Alternatively, in the embodiments, the second electrode plate 50 may be smaller than the first electrode plate 40 in a plan view.

In the embodiments, the thickness of the insulating film 303 in which the first electrode vias 64 are provided can be freely modified. In one example, the insulating film 303 may be thicker than the insulating films 304 and 306 in which the first wiring lines 62A and 62B are provided, for example. Additionally, the insulating film in which the first electrode vias 64 are provided may have a laminate structure of a plurality of insulating films.

In the embodiments, the thickness of the insulating film 307 in which the second electrode vias 74 are provided can be freely modified. In one example, the insulating film 307 may be thicker than the insulating films 304 and 306 in which the second wiring lines 72A and 72B are provided, for example. Additionally, the insulating film in which the second electrode vias 74 are provided may have a laminate structure of a plurality of insulating films.

In the embodiments, the second electrode plate 50 may be omitted.

In the embodiments, the first electrode plate 40 need not be electrically connected to the semiconductor substrate 20.

In the embodiments, the capacitor 10 may include an insulating substrate instead of the semiconductor substrate 20.

One or more of the various examples set forth in the present disclosure can be combined as long as such a combination is technically compatible.

Language used in the present disclosure such as “over” can include meanings such as “on” or “above” as long as the context does not eliminate each of those possibilities. Thus, the expression “the first element is disposed over the second element” is intended to allow for a given embodiment in which the first element is directly disposed on the second element in contact therewith, and another embodiment in which the first element is disposed above the second element without being in contact therewith. That is, the term “over” does not eliminate a structure in which another element is formed between the first element and the second element.

The Z direction used in the present disclosure need not necessarily indicate the vertical direction, and need not completely match the vertical direction. Thus, in the various structures of this disclosure, “up” and “down” in the Z axis direction described in the present disclosure are not limited to signifying “up” and “down” in the vertical direction. The X direction or the Y direction may be the vertical direction, for example.

### Notes

The technical concepts that can be ascertained from the present disclosure will be described below. The constituent elements disclosed in the notes below include the reference characters of the corresponding constituent elements of the embodiments above in order to aid understanding, rather than to limit the invention. The reference characters indicate examples to aid understanding, and the constituent elements disclosed in the notes should not be understood as being limited to the constituent elements indicated by the reference characters.

### Note 1

A capacitor (10), including:
a substrate (20) including a first substrate surface (21);
an insulating layer (30) provided on the first substrate surface (21); and
a first electrode (PE1) and a second electrode (PE2) that are provided in the insulating layer (30) and that oppose each other,
wherein the first electrode (PE1) includes a first electrode plate (40) and a plurality of first electrode parts (60),
wherein the second electrode (PE2) includes a second electrode plate (50) and a plurality of second electrode parts (70),
wherein the first electrode plate (40) is provided towards the first substrate surface (21) within the insulating layer (30), and opposes the first substrate surface (21),
wherein the second electrode plate (50) is positioned across the first electrode plate (40) from the first substrate surface (21) within the insulating layer (30), and provided so as to oppose the first electrode plate (40),
wherein the plurality of first electrode parts (60) are disposed between the first electrode plate (40) and the second electrode plate (50), and are electrically connected to the first electrode plate (40),
wherein the plurality of second electrode parts (70) are disposed between the second electrode plate (50) and the first electrode plate (40), and are electrically connected to the second electrode plate (50),
wherein the plurality of first electrode parts (60) and the plurality of second electrode parts (70) are disposed alternately in a first direction (X) perpendicular to a thickness direction (Z) of the substrate (20), and oppose each other in the first direction (X), and
wherein the first electrode plate (40) is interposed between the plurality of second electrode parts (70) and the substrate (20).

### Note 2

The capacitor according to Note 1,
wherein each of the first electrode parts (60) is constituted of a plurality of first conductive layers (61) that are stacked from the first electrode plate (40) towards the second electrode plate (50), and
wherein each of the second electrode parts (70) is constituted of a plurality of second conductive layers (71) that are stacked from the second electrode plate (50) towards the first electrode plate (40).

### Note 3

The capacitor according to Note 2,
wherein the plurality of first conductive layers (61) include:
a plurality of first wiring lines (62A, 62B) arrayed in the thickness direction (Z);
a first via (63) that electrically connects said first wiring lines (62A, 62B) that are adjacent to each other in the thickness direction (Z); and
a first electrode via (64) that connects, to the first electrode plate (40), a first wiring line (62A) closest to the first electrode plate (40), among the plurality of first wiring lines (62A, 62B), and
wherein the plurality of second conductive layers (71) include:
a plurality of second wiring lines (72A, 72B) arrayed in the thickness direction (Z);
a second via (73) that electrically connects said second wiring lines (72A, 72B) that are adjacent to each other in the thickness direction (Z); and
a second electrode via (74) that connects, to the second electrode plate (50), a second wiring line (72A) closest to the second electrode plate (50), among the plurality of second wiring lines (72A, 72B).

### Note 4

The capacitor according to Note 3,
wherein each of the plurality of first wiring lines (62A, 62B) extends along a second direction (Y) that is perpendicular to the first direction (X) as viewed from the thickness direction (Z),
wherein the first wiring lines (62A, 62B) that are adjacent to each other in the thickness direction (Z) are electrically connected by a plurality of the first vias (63),
wherein each of the plurality of second wiring lines (72A, 72B) extends in the second direction (Y), and
wherein the second wiring lines (72A, 72B) that are adjacent to each other in the thickness direction (Z) are electrically connected by a plurality of the second vias (73).

### Note 5

The capacitor according to Note 3 or 4,
wherein the plurality of first wiring lines (62A, 62B) and the plurality of second wiring lines (72A, 72B) oppose each other in the first direction (X).

### Note 6

The capacitor according to any one of Notes 3 to 5,
wherein, where a direction perpendicular to the first direction (X) as viewed from the thickness direction (Z) is defined as a second direction (Y),
a length (L1A, L1B) of each of the plurality of first wiring lines (62A, 62B) in the second direction (Y) is equal to a length (L2A, L2B) of each of the plurality of second wiring lines (72A, 72B) in the second direction (Y).

### Note 7

The capacitor according to any one of Notes 3 to 6,
wherein each of a plurality of the first vias (63) opposes each of a plurality of the second vias (73) in the first direction (X).

### Note 8

The capacitor according to any one of Notes 3 to 7,
wherein each of the second wiring lines (72A, 72B) is disposed in a center, in the first direction (X), between two of the first wiring lines (62A, 62B) that are adjacent to each other in the first direction (X).

### Note 9

The capacitor according to any one of Notes 1 to 3,
wherein, where a direction perpendicular to the first direction (X) as viewed from the thickness direction (Z) is defined as a second direction (Y),
the plurality of first electrode parts (80) and the plurality of second electrode parts (90) are arrayed alternately in a second direction (Y) as viewed from the thickness direction (Z), and oppose each other in the second direction (Y).

### Note 10

The capacitor according to Note 9,
wherein the plurality of first electrode parts (80) and the plurality of second electrode parts (90) are arrayed so as to alternate one each in the first direction (X) and so as to alternate one each in the second direction (Y).

### Note 11

The capacitor according to Note 10,
wherein a distance (DG) between the first electrode parts (80) and the second electrode parts (90) in the first direction (X) is equal to a distance (DH) between the first electrode parts (80) and the second electrode parts (90) in the second direction (Y).

### Note 12

The capacitor according to any one of Notes 9 to 11,
wherein each of the first electrode parts (80) is constituted of a plurality of first conductive layers (81) that are stacked from the first electrode plate (40) towards the second electrode plate (50), and
wherein each of the second electrode parts (90) is constituted of a plurality of second conductive layers (91) that are stacked from the second electrode plate (50) towards the first electrode plate (40).

### Note 13

The capacitor according to Note 12,
wherein the plurality of first conductive layers (81) include:
a plurality of first wiring lines (82A, 82B) arrayed in the thickness direction (Z);
a first via (83) that electrically connects said first wiring lines (82A, 82B) that are adjacent to each other in the thickness direction (Z); and
a first electrode via (84) that connects, to the first electrode plate (40), a first wiring line (82A) closest to the first electrode plate (40), among the plurality of first wiring lines (82A, 82B),
wherein the plurality of second conductive layers (91) include:
a plurality of second wiring lines (92A, 92B) arrayed in the thickness direction (Z);
a second via (93) that electrically connects said second wiring lines (92A, 92B) that are adjacent to each other in the thickness direction (Z); and
a second electrode via (94) that connects, to the second electrode plate (50), a second wiring line (92A) closest to the second electrode plate (50), among the plurality of second wiring lines (92A, 92B), and
wherein the plurality of first wiring lines (82A, 82B) and the plurality of second wiring lines (92A, 92B) oppose each other in both the first direction (X) and the second direction (Y).

### Note 14

The capacitor according to Note 13,
wherein a plurality of the first vias (83) and a plurality of the second vias (93) oppose each other in both the first direction (X) and the second direction (Y).

### Note 15

The capacitor according to any one of Notes 1 to 14,
wherein the second electrode plate (50) opposes each of the plurality of first electrode parts (60/80) while being positioned farther to a side opposite to the first substrate surface (21) as compared to the plurality of first electrode parts (60/80) in the thickness direction (Z).

### Note 16

The capacitor according to any one of Notes 1 to 15,
wherein the second electrode plate (50) and the plurality of second electrode parts (70/90) are disposed within a range overlapping the first electrode plate (40) as viewed from the thickness direction (Z).

### Note 17

The capacitor according to any one of Notes 1 to 16,
wherein the insulating layer (30) is made of an oxide film.

### Note 18

The capacitor according to Note 17,
wherein the insulating layer (30) is made of a material including SiO₂.

### Note 19

The capacitor according to any one of Notes 1 to 18,
wherein the substrate (20) is a semiconductor substrate, and
wherein the first electrode plate (40) is electrically connected to the substrate (20).

### Note 20

The capacitor according to any one of Notes 1 to 19,
wherein the first electrode plate (40) includes a slit (41) provided at a position differing from the plurality of second electrode parts (70) as viewed from the thickness direction (Z).

### Note 21

The capacitor according to any one of Notes 3 to 8, 13, and 14,
wherein the first electrode plate (40) and the plurality of first wiring lines (62A, 62B/82A, 82B) are made of the same material.

### Note 22

The capacitor according to any one of Notes 3 to 8, 13, and 14,
wherein the second electrode plate (50) and the plurality of second wiring lines (72A, 72B/92A, 92B) are made of the same material.

### Note 23

The capacitor according to any one of Notes 3 to 8, 13, and 14,
wherein the first electrode plate (40), the plurality of first wiring lines (62A, 62B/82A, 82B), the second electrode plate (50), and the plurality of second wiring lines (72A, 72B/92A, 92B) are made of the same material.

### Note 24

The capacitor according to any one of Notes 3 to 8, 13, and 14,
wherein the first electrode plate (40), the plurality of first wiring lines (62A, 62B/82A, 82B), the second electrode plate (50), and the plurality of second wiring lines (72A, 72B/92A, 92B) are made of at least one of aluminum and copper.

### Note 25

The capacitor according to any one of Notes 3 to 8, 13, and 14,
wherein the plurality of first wiring lines (62A, 62B) and the plurality of second wiring lines (72A, 72B) include sections that oppose each other in the thickness direction (Z).

### Note 26

The capacitor according to any one of Notes 3 to 8, 13, and 14,
wherein the plurality of first wiring lines (62A, 62B) and the plurality of second wiring lines (72A, 72B) each have a shape that tapers in the thickness direction (Z) so as to be narrower towards the substrate (20), and
wherein the first via (63) and the second via (73) each have a shape that tapers in the thickness direction (Z) so as to be narrower towards the substrate (20),

### Note 27

The capacitor according to any one of Notes 3 to 8,
wherein, where a direction perpendicular to the first direction (X) as viewed from the thickness direction (Z) is defined as a second direction (Y),
a length of the first via (63) in the second direction (Y) is equal to a length (L1A, L1B) of the first wiring lines (62A, 62B) in the second direction (Y), and
a length of the second via (73) in the second direction (Y) is equal to a length (L2A, L2B) of the second wiring lines (72A, 72B) in the second direction (Y).

### Note 28

An analog-digital converter (100), including:
an analog-digital (AD) conversion unit (110) that includes:
a comparator (111) including the capacitor (10) according to any one of Notes 1 to 27; and
a data generation unit (114) that includes a successive approximation register and generates digital data,
wherein the comparator (111) is configured so as to sample an input signal that is an analog signal, and compare the sampled input signal to analog data converted by the data generation unit (114) using a DA converter,
wherein the data generation unit (114) is configured so as to update the digital data according to a comparison result by the comparator (111), and
wherein the AD conversion unit (110) is configured so as to output an output signal according to the comparison result by the comparator (111).

The descriptions above are merely examples. Aside from the constituent elements and methods (manufacturing processes) cited above for the purpose of explaining the techniques of the present disclosure, a person having ordinary skill in the art would understand that more combinations and replacements could be conceived of. The present disclosure is intended to encompass all replacements, changes, and modifications included in the scope of the present disclosure including the claims.

What is claimed is:

1. A capacitor, comprising:
a substrate including a first substrate surface;
an insulating layer provided on the first substrate surface; and
a first electrode and a second electrode that are provided in the insulating layer and that oppose each other,
wherein the first electrode includes a first electrode plate and a plurality of first electrode parts,
wherein the second electrode includes a second electrode plate and a plurality of second electrode parts,
wherein the first electrode plate is closer to the first substrate surface within the insulating layer than is the second electrode plate, and opposes the first substrate surface,
wherein the second electrode plate is positioned across the first electrode plate from the first substrate surface within the insulating layer, and provided so as to oppose the first electrode plate,
wherein the plurality of first electrode parts are disposed between the first electrode plate and the second electrode plate, and are electrically connected to the first electrode plate,
wherein the plurality of second electrode parts are disposed between the second electrode plate and the first electrode plate, and are electrically connected to the second electrode plate,
wherein the plurality of first electrode parts and the plurality of second electrode parts are disposed alternately in a first direction perpendicular to a thickness direction of the substrate, and oppose each other in the first direction, and
wherein the first electrode plate is interposed between the plurality of second electrode parts and the substrate.

2. The capacitor according to claim 1,
wherein each of the first electrode parts is constituted of a plurality of first conductive layers that are stacked from the first electrode plate towards the second electrode plate, and
wherein each of the second electrode parts is constituted of a plurality of second conductive layers that are stacked from the second electrode plate towards the first electrode plate.

3. The capacitor according to claim 2,
wherein the plurality of first conductive layers include:
a plurality of first wiring lines arrayed in the thickness direction;
a first via that electrically connects said first wiring lines, said first wiring lines being adjacent to each other in the thickness direction; and
a first electrode via that connects, to the first electrode plate, a first wiring line closest to the first electrode plate, among the plurality of first wiring lines, and
wherein the plurality of second conductive layers include:
a plurality of second wiring lines arrayed in the thickness direction;
a second via that electrically connects said second wiring lines, said second wiring lines being adjacent to each other in the thickness direction; and
a second electrode via that connects, to the second electrode plate, a second wiring line closest to the second electrode plate, among the plurality of second wiring lines.

4. The capacitor according to claim 3,
wherein each of the plurality of first wiring lines extends along a second direction that is perpendicular to the first direction as viewed from the thickness direction,
wherein the first wiring lines that are adjacent to each other in the thickness direction are electrically connected by a plurality of the first vias,
wherein each of the plurality of second wiring lines extends in the second direction, and
wherein the second wiring lines that are adjacent to each other in the thickness direction are electrically connected by a plurality of the second vias.

5. The capacitor according to claim 3,
wherein the plurality of first wiring lines and the plurality of second wiring lines oppose each other in the first direction.

6. The capacitor according to claim 3,
wherein, where a direction perpendicular to the first direction as viewed from the thickness direction is defined as a second direction,
a length of each of the plurality of first wiring lines in the second direction is equal to a length of each of the plurality of second wiring lines in the second direction.

7. The capacitor according to claim 3,
wherein each of a plurality of the first vias opposes a corresponding one of a plurality of the second vias in the first direction.

8. The capacitor according to claim 3,
wherein each of the second wiring lines is disposed, in the first direction, between two of the first wiring lines that are adjacent to each other in the first direction.

9. The capacitor according to claim 1,
wherein the plurality of first electrode parts and the plurality of second electrode parts are arrayed alternately in a second direction perpendicular to the first direction as viewed from the thickness direction, and oppose each other in the second direction.

10. The capacitor according to claim 9,
wherein the plurality of first electrode parts and the plurality of second electrode parts are arrayed so as to alternate in the first direction and so as to alternate in the second direction.

11. The capacitor according to claim 10,
wherein a distance between the first electrode parts and the second electrode parts in the first direction is equal to a distance between the first electrode parts and the second electrode parts in the second direction.

12. The capacitor according to claim 9,
wherein each of the first electrode parts is constituted of a plurality of first conductive layers that are stacked from the first electrode plate towards the second electrode plate, and
wherein each of the second electrode parts is constituted of a plurality of second conductive layers that are stacked from the second electrode plate towards the first electrode plate.

13. The capacitor according to claim 12,
wherein the plurality of first conductive layers include:
a plurality of first wiring lines arrayed in the thickness direction;
a first via that electrically connects said first wiring lines, said first wiring lines being adjacent to each other in the thickness direction; and
a first electrode via that connects, to the first electrode plate, a first wiring line closest to the first electrode plate, among the plurality of first wiring lines,
wherein the plurality of second conductive layers include:
a plurality of second wiring lines arrayed in the thickness direction;
a second via that electrically connects said second wiring lines, said second wiring lines being adjacent to each other in the thickness direction; and
a second electrode via that connects, to the second electrode plate, a second wiring line closest to the second electrode plate, among the plurality of second wiring lines, and
wherein the plurality of first wiring lines and the plurality of second wiring lines oppose each other in both the first direction and the second direction.

14. The capacitor according to claim 13,
wherein a plurality of the first vias and a plurality of the second vias oppose each other in both the first direction and the second direction.

15. The capacitor according to claim 1,
wherein the second electrode plate opposes each of the plurality of first electrode parts while being positioned farther to a side opposite to the first substrate surface as compared to the plurality of first electrode parts in the thickness direction.

16. The capacitor according to claim 1,
wherein the second electrode plate and the plurality of second electrode parts are disposed within a range overlapping the first electrode plate as viewed from the thickness direction.

17. The capacitor according to claim 1,
wherein the insulating layer is made of an oxide film.

18. The capacitor according to claim 17,
wherein the insulating layer is made of a material including SiO₂.

19. The capacitor according to claim 1,
wherein the substrate is a semiconductor substrate, and
wherein the first electrode plate is electrically connected to the substrate.

20. The capacitor according to claim 1,
wherein the first electrode plate includes a slit provided at a position differing from a position of the plurality of second electrode parts as viewed from the thickness direction.
